(19) United States
(12) Patent Application Publication
(10) Pub. No.: US 2017/0262557 A1
(43) Pub. Date: Sep. 14, 2017

(54) METHOD OF ANALYZING SEMICONDUCTOR DEVICES AND ANALYSIS APPARATUS FOR SEMICONDUCTOR DEVICES

(71) Applicant: SAMSUNG ELECTRONICS CO., LTD., SUWON-SI (KR)

(72) Inventors: KATSUHIRO SHIMAZU, SEONGNAM-SI (KR); IN-SUNG HWANG, YONGIN-SI (KR); KWANG-OK JEONG, HWASEONG-SI (KR)

(21) Appl. No.: 15/346,979

(22) Filed: Nov. 9, 2016

(30) Foreign Application Priority Data
Mar. 11, 2016 (KR) 10-2016-0029725

(51) Int. Cl. G06F 17/50

(52) U.S. Cl. CPC G06F 17/5009; G06F 17/5081

(57) ABSTRACT

In a method of analyzing a semiconductor device, output values of semiconductor devices are measured, population data including the output values in connection with values of design attributes of the semiconductor devices is determined, outlier output values are extracted from among the output values included in the population data to determine discriminated data, and a weak value of a weak design attribute, which causes the outlier output values, is determined based on a difference between a ratio of a number of outlier output values, which are related with respective values of the design attributes, to a total number of the outlier output values included in the discriminated data, and a ratio of a number of output values, which are related with respective values of the design attributes, to a total number of the output values included in the population data.

### CROSS-REFERENCE TO RELATED APPLICATION

A claim for priority under 35 U.S.C. §119 is made to Korean Patent Application No. 10-2016-0029725, filed on Mar. 11, 2016 in the Korean Intellectual Property Office (KIPO), the disclosure of which is incorporated herein in its entirety by reference.

### BACKGROUND

The inventive concepts described herein relate to analysis of semiconductor devices, and more particularly to a method of analyzing semiconductor devices and an analysis apparatus for semiconductor devices.

A variety of design attributes or features may be considered in the design and manufacture of semiconductor devices. In the design stage of a semiconductor device, to increase the yield of the semiconductor device ultimately manufactured, design attributes which would likely result in operational errors of a manufactured semiconductor device are avoided. Design attributes most likely related to errors in operation of a semiconductor device are typically determined by analyzing the effects of the design attributes during operation of a manufactured test semiconductor devices.

However, since many design attributes may be applied to a semiconductor device, and since the effects of the design attributes on the operation of a manufactured semiconductor device are dependent on each other, it may be difficult to correctly determine a design attribute which likely results in operational error in the manufactured semiconductor device.

### SUMMARY

Embodiments of the inventive concept are directed to providing a method of analyzing a semiconductor device that effectively determines a design attribute and a value of the design attribute which causes an error in the operation of the semiconductor device.

Embodiments of the inventive concept are directed to providing an analysis apparatus for a semiconductor device that effectively determines a design attribute and a value of the design attribute which causes an error in the operation of the semiconductor device.

Embodiments of the inventive concept provide a method of analyzing a semiconductor device including measuring a plurality of output values of a plurality of semiconductor devices; determining population data including the plurality of output values corresponding with values of a plurality of design attributes of each of the plurality of semiconductor devices; extracting a plurality of outlier output values from among the plurality of output values included in the population data to determine discriminated data; and determining a weak design attribute from among the plurality of design attributes and a weak value of the weak design attribute which causes the outlier output values, based on a difference between a first ratio of a number of outlier output values, which are related with respective values of the plurality of design attributes, from among the plurality of outlier output values included in the discriminated data to a total number of the plurality of outlier output values included in the discriminated data, and a second ratio of a number of output values, which are related with respective values of the plurality of design attributes, from among the plurality of output values included in the population data to a total number of the plurality of output values included in the population data.

Embodiments of the inventive concept provide a method of analyzing a semiconductor device including measuring a plurality of output values of a plurality of semiconductor devices; determining population data including the plurality of output values corresponding with values of a plurality of design attributes of each of the plurality of semiconductor devices; extracting a plurality of outlier output values from among the plurality of output values included in the population data to determine discriminated data; determining a first weak design attribute from among the plurality of design attributes and a first weak value of the first weak design attribute, which causes the outlier output values, based on values of design attributes related with the plurality of outlier output values included in the discriminated data and values of design attributes related with the plurality of output values included in the population data; extracting output values, which are related with the first weak value of the first weak design attribute, from among the plurality of output values included in the population data to determine first new population data; and determining a second weak design attribute from among the plurality of design attributes and a second weak value of the second weak design attribute, which causes the outlier output values, based on the first new population data.

Embodiments of the inventive concept provide a method of manufacturing a semiconductor device including forming a plurality of test semiconductor devices having a plurality of design attributes; measuring a plurality of output values of the plurality of test semiconductor devices; determining population data including the plurality of output values corresponding with values of the plurality of design attributes of each of the plurality of semiconductor devices; extracting a plurality of outlier output values from among the plurality of output values included in the population data to determine discriminated data; determining a weak design attribute from among the plurality of design attributes and a weak value of the weak design attribute which causes the outlier output values, based on a difference between a first ratio of a number of outlier output values, which are related with respective values of the plurality of design attributes, from among the plurality of outlier output values included in the discriminated data to a total number of the plurality of outlier output values included in the discriminated data, and a second ratio of a number of output values, which are related with respective values of the plurality of design attributes, from among the plurality of output values included in the population data to a total number of the plurality of output values included in the population data; and manufacturing the semiconductor device using design attributes from among the plurality of design attributes excluding the weak value of the weak design attributes.

### BRIEF DESCRIPTION OF THE DRAWINGS

Illustrative, non-limiting example embodiments of the inventive concept will be more clearly understood from the following detailed description in conjunction with the accompanying drawings.

FIG. 1 illustrates a block diagram of a semiconductor device analysis system according to an embodiment of the inventive concept.

FIG. 2 illustrates a block diagram of an example of a semiconductor chips having a plurality of semiconductor devices used in the semiconductor device analysis system of FIG. 1.

FIG. 3 illustrates a block diagram of an example of a semiconductor device analysis apparatus included in the semiconductor device analysis system of FIG. 1.

FIG. 4 illustrates a diagram of an example of a design attribute table included in a storage device of FIG. 3.

FIG. 5 illustrates a flow chart of a method of analyzing a semiconductor device according to an embodiment of the inventive concept.

FIG. 6 illustrates a flow chart of an example of a process of extracting the plurality of outlier output values among the plurality of output values included in the population data to determine the discriminated data of FIG. 5.

FIG. 7 illustrates a diagram for describing the process of extracting the plurality of outlier output values among the plurality of output values included in the population data to determine the discriminated data of FIG. 6.

FIG. 8 illustrates a flow chart of another example of a process of extracting the plurality of outlier output values among the plurality of output values included in the population data to determine the discriminated data of FIG. 5.

FIG. 9 illustrates a diagram for describing the process of extracting the plurality of outlier output values among the plurality of output values included in the population data to determine the discriminated data of FIG. 8.

FIGS. 10A and 10B illustrate a flow chart of an example of a process of determining a weak design attribute and a weak value of the weak design attribute of FIG. 5.

FIG. 11 illustrates a flow chart of an example of a process of determining a gap based on a difference between a first occurrence rate and a third occurrence rate of FIGS. 10A and 10B.

FIG. 12 illustrates a diagram for describing the process of determining a gap based on a difference between a first occurrence rate and a third occurrence rate of FIG. 11.

FIG. 13 illustrates a diagram for describing the process of determining a weak design attribute and a weak value of the weak design attribute of FIGS. 10A and 10B.

FIG. 14 illustrates a flow chart of a method of analyzing a semiconductor device according to an embodiment of the inventive concept.

FIG. 15 illustrates a flow chart of an example of a process of determining a second weak design attribute and a second weak value of the second weak design attribute of FIG. 14.

FIG. 16 illustrates a flow chart of another example of a process of determining a second weak design attribute and a second weak value of the second weak design attribute of FIG. 14.

FIGS. 17A and 17B illustrate a flow chart of a method of analyzing a semiconductor device according to an embodiment of the inventive concept.

FIGS. 18, 19, 20, 21, 22 and 23 illustrate diagrams for describing the method of analyzing a semiconductor device of FIGS. 17A and 17B.

FIG. 24 illustrates a diagram of an example of a semiconductor device generated based on a combination of weak values of weak design attributes, which are determined by the processes of FIGS. 18 to 23.

FIG. 25 illustrates a flow chart of a method of manufacturing a semiconductor device according to an embodiment of the inventive concept.

### DETAILED DESCRIPTION

As is traditional in the field of the inventive concepts, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the inventive concepts. Likewise, the blocks of the embodiments may be physically combined into more complex blocks without departing from the scope of the inventive concepts.

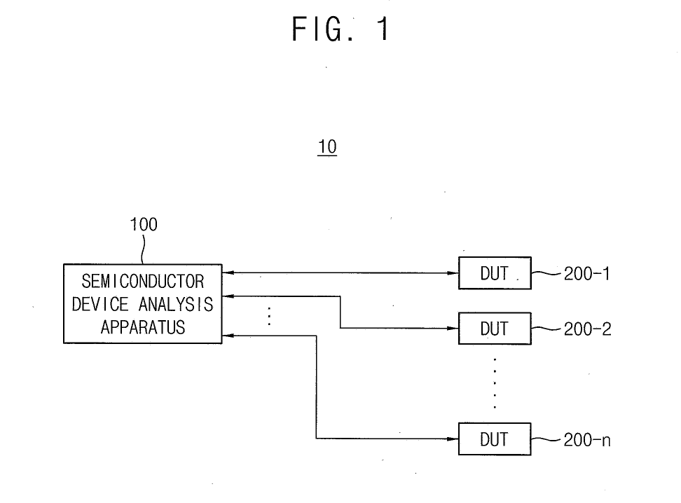

FIG. 1 illustrates a block diagram of a semiconductor device analysis system according to an embodiment of the inventive concept.

Referring to FIG. 1, a semiconductor device analysis system 10 includes a semiconductor device analysis apparatus 100 and a plurality of semiconductor devices DUT 200-1, 200-2, . . . , 200-n. Here, n represents a positive integer.

Each of the plurality of semiconductor devices 200-1, 200-2, . . . , 200-n may be manufactured based on various values of a plurality of design attributes. That is, each of the plurality of semiconductor devices 200-1, 200-2, . . . , 200-n may have a value for each of the plurality of design attributes.

The plurality of design attributes may include for example a type, a dimension, a layout parameter, or the like of each of the plurality of semiconductor devices 200-1, 200-2, . . . , 200-n.

In some embodiments, each of the plurality of semiconductor devices 200-1, 200-2, . . . , 200-n may for example correspond to a transistor. In such a case, the plurality of design attributes may include for example whether each of the plurality of semiconductor devices 200-1, 200-2, . . . , 200-n is an n-type transistor or a p-type transistor, whether an active region of each of the plurality of semiconductor devices 200-1, 200-2, . . . , 200-n is cut by a shallow trench, a gate length of each of the plurality of semiconductor devices 200-1, 200-2, . . . , 200-n, or the like. In addition, when the plurality of semiconductor devices 200-1, 200-2, . . . , 200-n are manufactured by a fin field effect transistor (FinFET) process, the plurality of design attributes may include for example a number of fins of each of the plurality of semiconductor devices 200-1, 200-2, . . . , 200-n, a difference between a number of fins of a corresponding semiconductor device and a number of fins of an adjacent semiconductor device, or the like.

However, embodiments of the inventive concept are not limited to transistors as the semiconductor devices. In other embodiments of the inventive concept, each of the plurality of semiconductor devices 200-1, 200-2, . . . , 200-n may correspond to any kind of semiconductor devices.

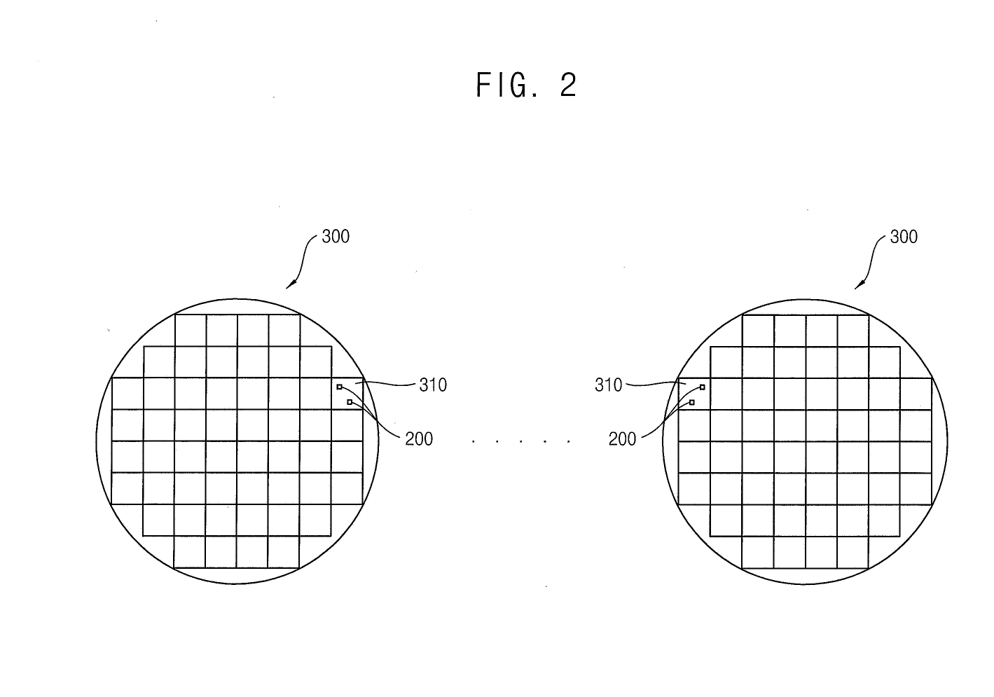

FIG. 2 illustrates a block diagram of an example of a semiconductor chip having a plurality of semiconductor devices used in the semiconductor device analysis system of FIG. 1.

As illustrated in FIG. 2, a plurality of semiconductor chips 310 may be formed on each of a plurality of semiconductor wafers 300, and each of the plurality of semiconductor chips 310 may include a plurality of semiconductor devices 200.

Each of the plurality of semiconductor chips 310 formed on the plurality of semiconductor wafers 300 may have a same structure.

The plurality of semiconductor devices 200 included in the semiconductor chip 310 may have different values from each other for each of the plurality of design attributes based on a circuit design implemented on the semiconductor chip 310.

The plurality of semiconductor devices 200-1, 200-2, . . . , 200-n included in the semiconductor device analysis system 10 of FIG. 1 may include the plurality of semiconductor devices 200 included in the plurality of semiconductor chips 310 formed on the plurality of semiconductor wafers 300.

Referring to FIG. 1, the semiconductor device analysis apparatus 100 may provide a control signal to each of the plurality of semiconductor devices 200-1, 200-2, . . . , 200-n, and may measure a magnitude of an output signal generated by each of the plurality of semiconductor devices 200-1, 200-2, . . . , 200-n responsive to the control signal as an output value.

For example, when each of the plurality of semiconductor devices 200-1, 200-2, . . . , 200-n corresponds to a transistor, the semiconductor device analysis apparatus 100 may measure a magnitude of a drain current of each of the plurality of semiconductor devices 200-1, 200-2, . . . , 200-n in a cut off state or a saturation state as the output value.

However, embodiments of the inventive concept are not limited to measuring drain current as the output value. In other embodiments of the inventive concept, the semiconductor device analysis apparatus 100 may measure a magnitude of any signal generated by each of the plurality of semiconductor devices 200-1, 200-2, . . . , 200-n as the output value.

The semiconductor device analysis apparatus 100 may determine a weak design attribute among the plurality of design attributes and a weak value of the weak design attribute, which have a high probability to cause an error in an operation of the plurality of semiconductor devices 200-1, 200-2, . . . , 200-n, based on the plurality of output values measured from the plurality of semiconductor devices 200-1, 200-2, . . . , 200-n and the values of the plurality of design attributes of the plurality of semiconductor devices 200-1, 200-2, . . . , 200-n.

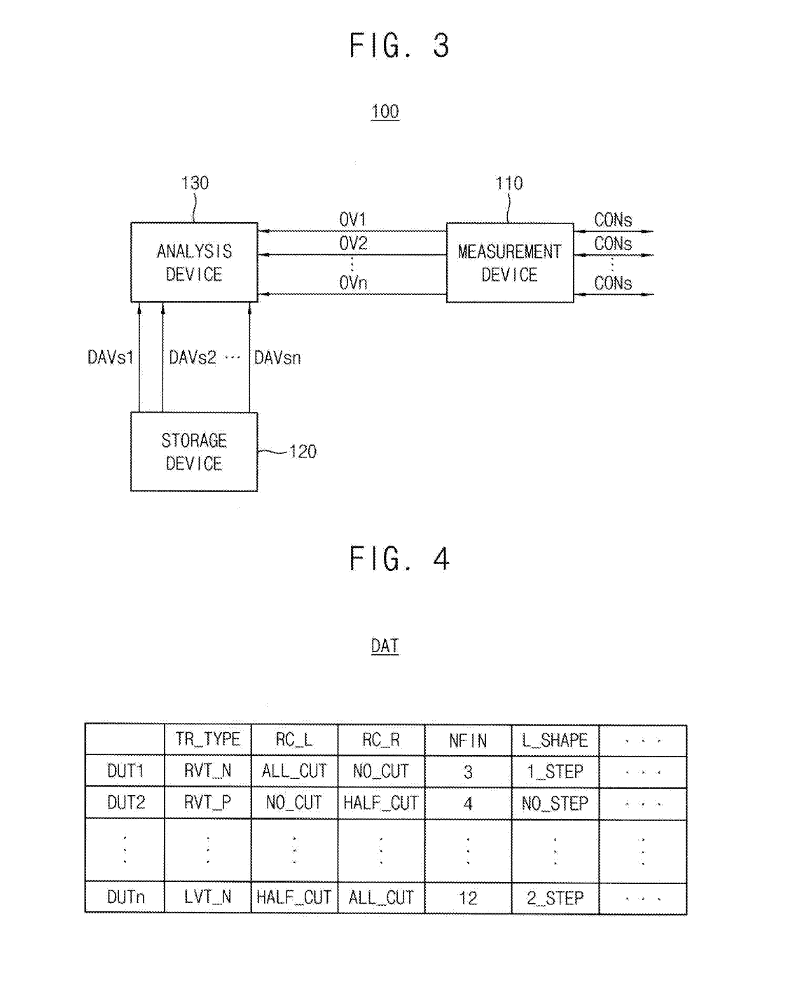

FIG. 3 illustrates a block diagram of an example of a semiconductor device analysis apparatus included in the semiconductor device analysis system of FIG. 1.

Referring to FIG. 3, the semiconductor device analysis apparatus 100 includes a measurement device 110, a storage device 120, and an analysis device 130.

The measurement device 110 may provide control signals CONs to each of the plurality of semiconductor devices 200-1, 200-2, . . . , 200-n, and may measure the plurality of output values OV1, OV2, . . . , OVn generated by the plurality of semiconductor devices 200-1, 200-2, . . . , 200-n based on the control signals CONs.

In some embodiments, to analyze characteristics of the plurality of semiconductor devices 200-1, 200-2, . . . , 200-n more correctly, the measurement device 110 may provide the control signals CONs to each of the plurality of semiconductor devices 200-1, 200-2, . . . , 200-n directly, and may measure the plurality of output values OV1, OV2, . . . , OVn generated by each of the plurality of semiconductor devices 200-1, 200-2, . . . , 200-n based on the control signals CONs before a manufacturing stage in which a wiring pattern is formed on the plurality of semiconductor devices 200-1, 200-2, . . . , 200-n.

The measurement device 110 may provide the plurality of output values OV1, OV2, . . . , OVn measured from the plurality of semiconductor devices 200-1, 200-2, . . . , 200-n to the analysis device 130.

The measurement device 110 may be physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The measurement device 110 may be implemented by dedicated hardware, or by a processor (e.g., one or more programmed microprocessors and associated circuitry), or by a combination of dedicated hardware to perform some functions and a processor to perform other functions. The analysis device 130 may be implemented to include a special-purpose circuit (e.g., field programmable gate arrays (FPGA), application specific integrated circuits (ASICs), and/or the like.

The storage device 120 may store the values of the plurality of design attributes of each of the plurality of semiconductor devices 200-1, 200-2, . . . , 200-n. The storage device 120 may include any type of storage memory.

In some embodiments, the storage device 120 may store the values of the plurality of design attributes of each of the plurality of semiconductor devices 200-1, 200-2, . . . , 200-n as a design attribute table DAT.

FIG. 4 illustrates a diagram of an example of a design attribute table included in a storage device of FIG. 3.

An example of the design attribute table DAT included in the storage device 120 is illustrated in FIG. 4, in a case where each of the plurality of semiconductor devices 200-1, 200-2, . . . , 200-n corresponds to a transistor.

First through fifth design attributes TR_TYPE, RC_L, RC_R, NFIN, and L_SHAPE among the plurality of design attributes of the plurality of semiconductor devices 200-1, 200-2, . . . , 200-n are represented in the design attribute table DAT of FIG. 4 as an example.

The first design attribute TR_TYPE may represent whether each of the plurality of semiconductor devices 200-1, 200-2, . . . , 200-n is an n-type transistor or a p-type transistor, and whether a threshold voltage of each of the plurality of semiconductor devices 200-1, 200-2, . . . , 200-n is relatively high or relatively low. For example, a semiconductor device may correspond to an n-type transistor having a regular threshold voltage when the first design attribute TR_TYPE of the semiconductor device has a first value RVT_N, a semiconductor device may correspond to a p-type transistor having a regular threshold voltage when the first design attribute TR_TYPE of the semiconductor device has a second value RVT_P, a semiconductor device may correspond to an n-type transistor having a low threshold voltage when the first design attribute TR_TYPE of the semiconductor device has a third value LVT_N, and a semiconductor device may correspond to a p-type transistor having a low threshold voltage when the first design attribute TR_TYPE of the semiconductor device has a fourth value LVT_P.

The second design attribute RC_L may represent whether a left active region of each of the plurality of semiconductor devices 200-1, 200-2, . . . , 200-n is cut by a shallow trench. For example, all portions of a left active region of a semiconductor device may be cut by a shallow trench when the second design attribute RC_L of the semiconductor device has a first value ALL_CUT, no portion of a left active region of a semiconductor device may be cut by a shallow trench when the second design attribute RC_L of the semiconductor device has a second value NO_CUT, and half portions of a left active region of a semiconductor device may be cut by a shallow trench when the second design attribute RC_L of the semiconductor device has a third value HALF_CUT.

The third design attribute RC_R may represent whether a right active region of each of the plurality of semiconductor devices 200-1, 200-2, . . . , 200-n is cut by a shallow trench. For example, all portions of a right active region of a semiconductor device may be cut by a shallow trench when the third design attribute RC_R of the semiconductor device has a first value ALL_CUT, no portion of a right active region of a semiconductor device may be cut by a shallow trench when the third design attribute RC_R of the semiconductor device has a second value NO_CUT, and half portions of a right active region of a semiconductor device may be cut by a shallow trench when the third design attribute RC_R of the semiconductor device has a third value HALF_CUT.

When the plurality of semiconductor devices 200-1, 200-2, . . . , 200-n are manufactured by a fin field effect transistor (FinFET) process, the fourth design attribute NFIN may represent a number of fins (e.g., 2, 3, . . . or 12 fins) of each of the plurality of semiconductor devices 200-1, 200-2, . . . , 200-n. In embodiments of the inventive concept, the number of fins NFIN of semiconductor devices manufactured by a FinFET process is not limited to the example numbers shown in the design attribute table DAT of FIG. 4.

When the plurality of semiconductor devices 200-1, 200-2, . . . , 200-n are manufactured by a fin field effect transistor (FinFET) process, the fifth design attribute L_SHAPE may represent a difference between a number of fins of a corresponding semiconductor device and a number of fins of an adjacent semiconductor device. For example, when the fifth design attribute L_SHAPE of the semiconductor device has a first value NO_STEP, the corresponding semiconductor device may have a same number of fins as an adjacent semiconductor device. When the fifth design attribute L_SHAPE of the semiconductor device has a second value 1_STEP, the difference between the number of fins of the corresponding semiconductor device and an adjacent semiconductor device may be 1. When the fifth design attribute L_SHAPE of the semiconductor device has a third value 2_STEP, the difference between the number of fins of the corresponding semiconductor device and an adjacent semiconductor device may be 2. In embodiments of the inventive concept, the value of fifth design attribute L_SHAPE is not limited to the example values shown in the design attribute table DAT of FIG. 4.

As illustrated in FIG. 4, the design attribute table DAT may store a value of each of the plurality of design attributes for each of the plurality of semiconductor devices DUT1, DUT2, . . . , DUTn.

Although the design attribute table DAT is illustrated in FIG. 4 to include the first through fifth design attributes TR_TYPE, RC_L, RC_R, NFIN, and L_SHAPE, embodiments of the inventive concept are not limited to the above noted design attributes. In other embodiments, the design attribute table DAT may store any kind of design attributes of the plurality of semiconductor devices DUT1, DUT2, . . . , DUTn.

Referring again to FIG. 3, the analysis device 130 may read the values DAVs1, DAVs2, . . . , DAVsn of the plurality of design attributes for the plurality of semiconductor devices 200-1, 200-2, . . . , 200-n from the storage device 120. For example, the analysis device 130 may read the values DAVs1 of the plurality of design attributes corresponding to the first semiconductor device 200-1, the values DAVs2 of the plurality of design attributes corresponding to the second semiconductor device 200-2, and the values DAVsn of the plurality of design attributes corresponding to the n-th semiconductor device 200-n from the design attribute table DAT stored in the storage device 120.

The analysis device 130 may determine a population data including the plurality of output values OV1, OV2, . . . , OVn corresponding to the plurality of semiconductor devices 200-1, 200-2, . . . , 200-n, which are received from the measure device 110, in connection with the values DAVs1, DAVs2, . . . , DAVsn of the plurality of design attributes of each of the plurality of semiconductor devices 200-1, 200-2, . . . , 200-n, which are read from the storage device 120. For example, the population data may include the k-th output value OVk measured from the k-th semiconductor device 200-k in connection with the values DAVsk of the plurality of design attributes of the k-th semiconductor device 200-k. Here, k represents a positive integer equal to or smaller than n. That is, in other words, in the population data the k-th output value OVk measured from the k-th semiconductor device 200-k may be grouped or paired as related to or corresponding with the values DAVsk of the plurality of design attributes of the k-th semiconductor device 200-k.

In addition, the analysis device 130 may extract a plurality of outlier output values, which have abnormal values, among the plurality of output values OV1, OV2, . . . , OVn included in the population data to determine a discriminated data.

After that, the analysis device 130 may determine a weak design attribute among the plurality of design attributes and a weak value of the weak design attribute, which causes the outlier output values in the plurality of semiconductor devices 200-1, 200-2, . . . , 200-n, based on a difference between a ratio in which each of the values of the plurality of design attributes is related with the plurality of outlier output values included in the discriminated data and a ratio in which each of the values of the plurality of design attributes is related with the plurality of output values OV1, OV2, . . . , OVn included in the population data.

The analysis device 130 may be physically implemented by a microprocessor or a microcontroller, memory circuits, hardwired circuits and the like, and may be driven by firmware and/or software as stored in the memory circuits. That is, the analysis device 130 may be implemented by dedicated hardware, or by a processor (e.g., one or more programmed microprocessors and associated circuitry), or by a combination of dedicated hardware to perform some functions and a processor to perform other functions. The analysis device 130 may be implemented to include a special-purpose circuit (e.g., field programmable gate arrays (FPGA), application specific integrated circuits (ASICs), and/or the like.

Although the semiconductor device analysis apparatus 100 is described to internally store the values DAVs1, DAVs2, . . . , DAVsn of the plurality of design attributes of each of the plurality of semiconductor devices 200-1, 200-2, . . . , 200-n in the storage device 120 with reference to FIG. 3, embodiments of the inventive concept are not limited to storing the values DAVs1, DAVs2, . . . , DAVsn in the storage device 120. In other embodiments, the semiconductor device analysis apparatus 100 may receive the values DAVs1, DAVs2, . . . , DAVsn of the plurality of design attributes of each of the plurality of semiconductor devices 200-1, 200-2, . . . , 200-n from outside the semiconductor device analysis apparatus 100.

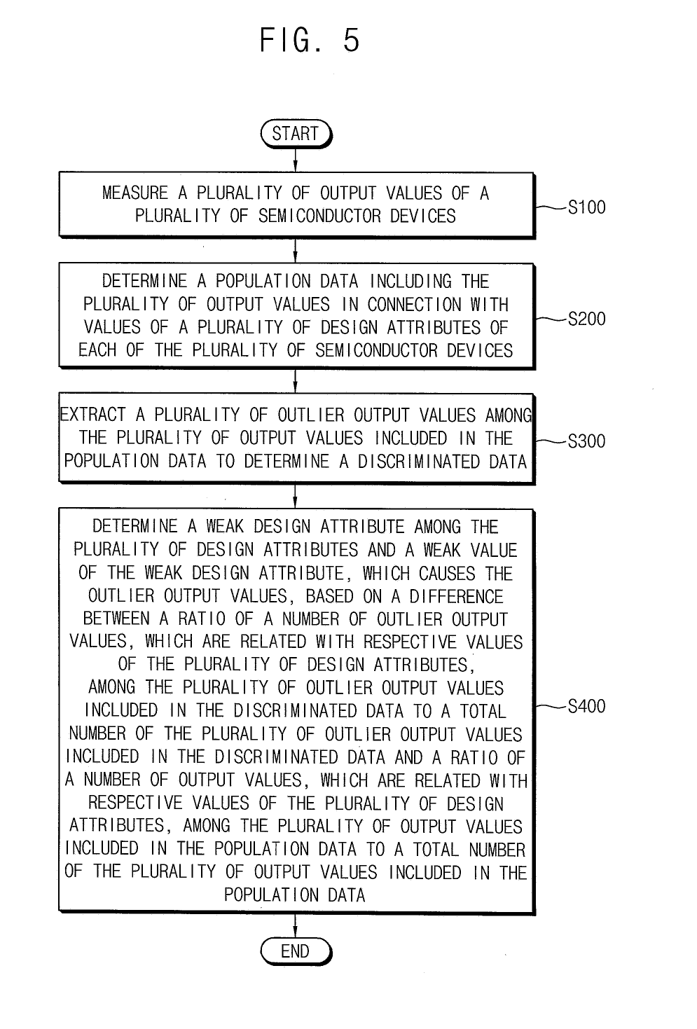

FIG. 5 illustrates a flow chart of a method of analyzing a semiconductor device according to an embodiment of the inventive concept.

The method of analyzing a semiconductor device of FIG. 5 may be performed by the semiconductor device analysis apparatus 100 included in the semiconductor device analysis system 10 of FIG. 1.

Hereinafter, the method of analyzing a semiconductor device performed by the semiconductor device analysis apparatus 100 will be described with reference to FIGS. 1 to 5.

Referring to FIG. 5, in step S100 the semiconductor device analysis apparatus 100 may measure the plurality of output values OV1, OV2, . . . , OVn of the plurality of semiconductor devices 200-1, 200-2, . . . , 200-n.

For example, the semiconductor device analysis apparatus 100 (i.e., measurement device 110) may provide the control signals CONs to each of the plurality of semiconductor devices 200-1, 200-2, . . . , 200-n, and may measure the plurality of output values OV1, OV2, . . . , OVn generated by the plurality of semiconductor devices 200-1, 200-2, . . . , 200-n based on the control signals CONs.

In step S200, the semiconductor device analysis apparatus 100 (i.e., analysis device 130) may determine the population data including the plurality of output values OV1, OV2, . . . , OVn, which are measured from the plurality of semiconductor devices 200-1, 200-2, . . . , 200-n, in connection with the values DAVs1, DAVs2, . . . , DAVsn of the plurality of design attributes of each of the plurality of semiconductor devices 200-1, 200-2, . . . , 200-n.

For example, the k-th output value OVk measured from the k-th semiconductor device 200-k may be connected with the values DAVsk of the plurality of design attributes of the k-th semiconductor device 200-k in the population data. That is, in other words, in the population data the k-th output value OVk measured from the k-th semiconductor device 200-k may be grouped or paired as related to or corresponding with the values DAVsk of the plurality of design attributes of the k-th semiconductor device 200-k.

After that in step S300, the semiconductor device analysis apparatus 100 may extract the plurality of outlier output values, which have abnormal values, among the plurality of output values OV1, OV2, . . . , OVn included in the population data to determine the discriminated data.

In some embodiments of the inventive concept, the semiconductor device analysis apparatus 100 (i.e., analysis device 130) may extract the plurality of outlier output values among the plurality of output values OV1, OV2, . . . , OVn included in the population data based on a difference between each of the plurality of output values OV1, OV2, . . . , OVn included in the population data and an average value of the plurality of output values OV1, OV2, . . . , OVn included in the population data, to determine the discriminated data. For example, the semiconductor device analysis apparatus 100 may extract output values, which have a great difference from the average value of the plurality of output values OV1, OV2, . . . , OVn, among the plurality of output values OV1, OV2, . . . , OVn included in the population data as the plurality of outlier output values, and determine the plurality of outlier output values as the discriminated data.

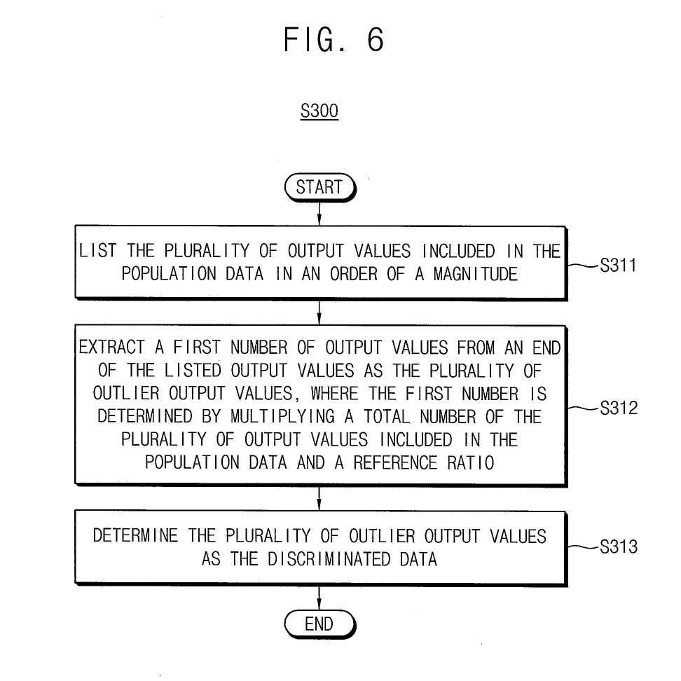

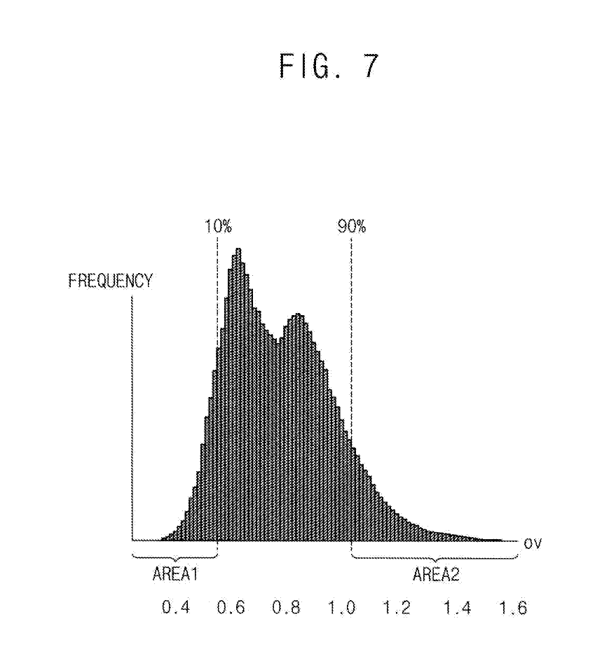

FIG. 6 illustrates a flow chart of an example of a process of extracting the plurality of outlier output values among the plurality of output values included in the population data to determine the discriminated data of FIG. 5. FIG. 7 illustrates a diagram for describing the process of extracting the plurality of outlier output values among the plurality of output values included in the population data to determine the discriminated data of FIG. 6.

Referring to FIG. 6, in step S311, the semiconductor device analysis apparatus 100 may list the plurality of output values OV1, OV2, . . . , OVn included in the population data in an order of a magnitude.

For example, as illustrated in FIG. 7, the semiconductor device analysis apparatus 100 may list the plurality of output values OV1, OV2, . . . , OVn included in the population data in an order of a magnitude by generating a frequency histogram of the plurality of output values OV1, OV2, . . . , OVn.

As described above with reference to FIG. 2, the plurality of semiconductor devices 200 included in a semiconductor chip 310 may have different values from each other for each of the plurality of design attributes based on a circuit design implemented on the semiconductor chip 310. Therefore, a target output value of each of the plurality of semiconductor devices 200-1, 200-2, . . . , 200-n may be different from each other. Therefore, the semiconductor device analysis apparatus 100 may generate the frequency histogram of the plurality of output values OV1, OV2, . . . , OVn after dividing each of the plurality of output values OV1, OV2, . . . , OVn by a target output value of each of the plurality of semiconductor devices 200-1, 200-2, . . . , 200-n.

That is, in the frequency histogram of FIG. 7, an x-axis may represent each of the plurality of output values OV1, OV2, . . . , OVn divided by the target output value of each of the plurality of semiconductor devices 200-1, 200-2, . . . , 200-n, and a y-axis may represent the frequency (i.e., the number of semiconductor devices which have the corresponding output value).

FIG. 7 represents a frequency histogram of the plurality of output values OV1, OV2, . . . , OVn as an example when each of the plurality of semiconductor devices 200-1, 200-2, . . . , 200-n corresponds to a transistor, and each of the plurality of output values OV1, OV2, . . . , OVn corresponds to a magnitude of a drain current of each of the plurality of semiconductor devices 200-1, 200-2, . . . , 200-n in a saturation state.

After that, in step S312, the semiconductor device analysis apparatus 100 may extract a first number of output values from an end of the listed output values OV1, OV2, . . . , OVn as the plurality of outlier output values, where the first number is determined by multiplying a total number of the plurality of output values OV1, OV2, . . . , OVn included in the population data and a reference ratio (step S312). In some embodiments of the inventive concept, the reference ratio may be predetermined.

In some embodiments of the inventive concept, the semiconductor device analysis apparatus 100 may extract the first number of output values, which have relatively small magnitudes, among the plurality of output values OV1, OV2, . . . , OVn included in the population data as the plurality of outlier output values. For example, as illustrated in FIG. 7, the semiconductor device analysis apparatus 100 may extract output values included in a first area AREA1, which corresponds to a lowest 10% of the frequency histogram, as the plurality of outlier output values.

In other embodiments, the semiconductor device analysis apparatus 100 may extract the first number of output values, which have relatively great magnitudes, among the plurality of output values OV1, OV2, . . . , OVn included in the population data as the plurality of outlier output values. For example, as illustrated in FIG. 7, the semiconductor device analysis apparatus 100 may extract output values included in a second area AREA2, which corresponds to a highest 10% of the frequency histogram, as the plurality of outlier output values.

After that, in step S313, the semiconductor device analysis apparatus 100 may determine the plurality of outlier output values as the discriminated data.

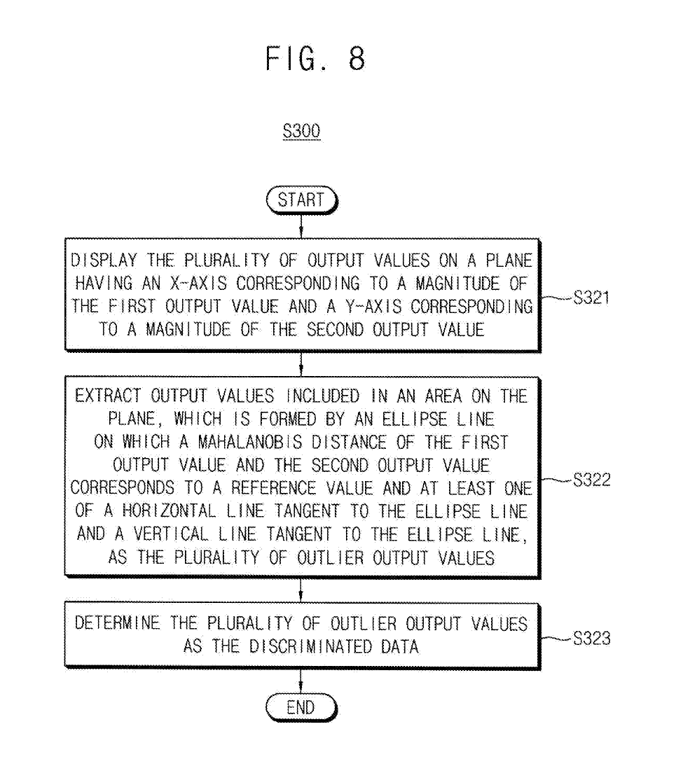

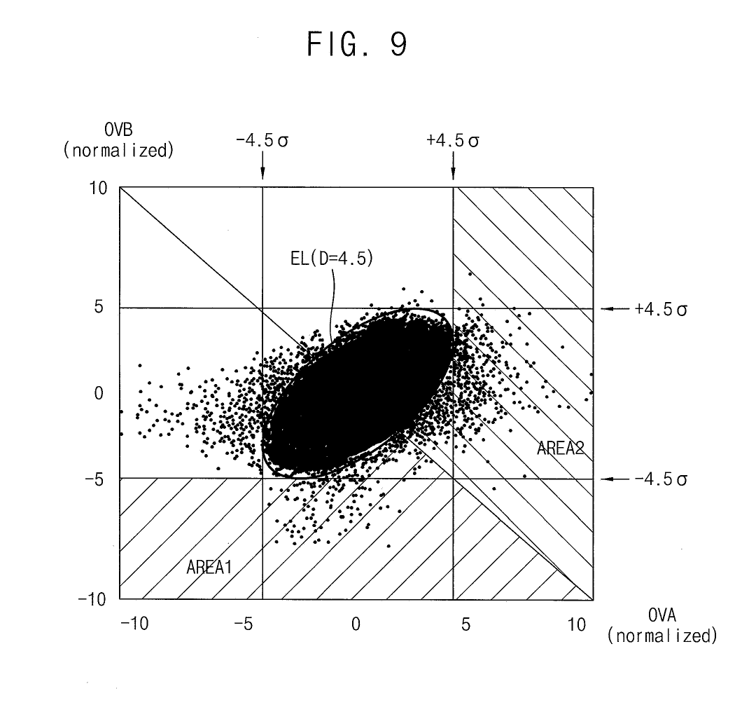

FIG. 8 illustrates a flow chart of another example of a process of extracting the plurality of outlier output values among the plurality of output values included in the population data to determine the discriminated data of FIG. 5. FIG. 9 illustrates a diagram for describing the process of extracting the plurality of outlier output values among the plurality of output values included in the population data to determine the discriminated data of FIG. 8.

In some embodiments of the inventive concept, each of the plurality of output values OV1, OV2, . . . , OVn included in the population data may include a pair of a first output value OVA and a second output value OVB. That is, the semiconductor device analysis apparatus 100 (i.e., measurement device 110) may measure magnitudes of two output signals, which are different from each other, generated by each of the plurality of semiconductor devices 200-1, 200-2, . . . , 200-n as the first output value OVA and the second output value OVB.

In this case, the semiconductor device analysis apparatus 100 (i.e., analysis device 130) in step S321 may display on a display of the analysis device 130 6the plurality of output values OV1, OV2, . . . , OVn included in the population data on a plane having an x-axis corresponding to a magnitude of the first output value OVA and a y-axis corresponding to a magnitude of the second output value OVB.

As described above with reference to FIG. 2, the plurality of semiconductor devices 200 included in the semiconductor chip 310 may have different values from each other for each of the plurality of design attributes based on a circuit design implemented on the semiconductor chip 310. Therefore, a target output value of each of the plurality of semiconductor devices 200-1, 200-2, . . . , 200-n may be different from each other.

Therefore, as illustrated in FIG. 9, the semiconductor device analysis apparatus 100 may display the plurality of output values OV1, OV2, . . . , OVn included in the population data on a plane having an x-axis corresponding to a normalized magnitude of the first output value OVA and a y-axis corresponding to a normalized magnitude of the second output value OVB.

FIG. 9 represents a graph of the plurality of output values OV1, OV2, . . . , OVn as an example when each of the plurality of semiconductor devices 200-1, 200-2, . . . , 200-n corresponds to a transistor, the first output value OVA included in each of the plurality of output values OV1, OV2, . . . , OVn corresponds to a magnitude of a drain current of each of the plurality of semiconductor devices 200-1, 200-2, . . . , 200-n in a cut off state, and the second output value OVB included in each of the plurality of output values OV1, OV2, . . . , OVn corresponds to a magnitude of a drain current of each of the plurality of semiconductor devices 200-1, 200-2, . . . , 200-n in a saturation state.

After that, in step S322, the semiconductor device analysis apparatus 100 may extract output values included in an area on the plane, which is formed by an ellipse line EL on which a Mahalanobis distance of the normalized first output value and the normalized second output value corresponds to a reference value, and at least one of a horizontal line tangent to the ellipse line EL and a vertical line tangent to the ellipse line EL, as the plurality of outlier output values. In some example embodiments, the reference value may be predetermined.

For example, the ellipse line EL on which the Mahalanobis distance of the normalized first output value and the normalized second output value corresponds to 4.5, two horizontal lines tangent to the ellipse line EL and two vertical lines tangent to the ellipse line EL are illustrated in FIG. 9. The two vertical lines tangent to the ellipse line EL having the Mahalanobis distance of 4.5 may represent a line corresponding to 4.5 times of a standard deviation σ of the normalized first output value and a line corresponding to −4.5 times of the standard deviation σ of the normalized first output value. In addition, the two horizontal lines tangent to the ellipse line EL having the Mahalanobis distance of 4.5 may represent a line corresponding to 4.5 times of a standard deviation σ of the normalized second output value and a line corresponding to −4.5 times of the standard deviation σ of the normalized second output value.

In some embodiments of the inventive concept, as illustrated in FIG. 9, the semiconductor device analysis apparatus 100 may extract output values included in a first area AREA1 on the plane, which is formed by the ellipse line EL, the horizontal line tangent to the ellipse line EL, and a diagonal line crossing the ellipse line EL, as the plurality of outlier output values. In this case, the plurality of outlier output values may correspond to output values, which include the second output value OVB having a relatively small magnitude, among the plurality of output values OV1, OV2, . . . , OVn included in the population data.

In other embodiments, as illustrated in FIG. 9, the semiconductor device analysis apparatus 100 may extract output values included in a second area AREA2 on the plane, which is formed by the ellipse line EL, the vertical line tangent to the ellipse line EL, and the diagonal line crossing the ellipse line EL, as the plurality of outlier output values. In this case, the plurality of outlier output values may correspond to output values, which include the first output value OVA having a relatively great magnitude, among the plurality of output values OV1, OV2, . . . , OVn included in the population data.

After that, in step S323, the semiconductor device analysis apparatus 100 may determine the plurality of outlier output values as the discriminated data.

Although examples of the process of extracting the plurality of outlier output values among the plurality of output values OV1, OV2, . . . , OVn included in the population data to determine the discriminated data are described above with reference to FIGS. 6 to 9, embodiments of the inventive concept are not limited to the extraction described with respect to FIGS. 6 to 9. In other embodiments, the semiconductor device analysis apparatus 100 may extract output values, which have a great difference from the average value of the plurality of output values OV1, OV2, . . . , OVn, among the plurality of output values OV1, OV2, . . . , OVn included in the population data as the plurality of outlier output values, and may determine the plurality of outlier output values as the discriminated data using various methods.

Referring again to FIG. 5, the semiconductor device analysis apparatus 100 (i.e., analysis device 130) may determine a weak design attribute among the plurality of design attributes and a weak value of the weak design attribute, which causes the outlier output values in the plurality of semiconductor devices 200-1, 200-2, . . . , 200-n, based on a difference between a ratio in which each of the values of the plurality of design attributes is related with the plurality of outlier output values included in the discriminated data, and a ratio in which each of the values of the plurality of design attributes is related with the plurality of output values OV1, OV2, . . . , OVn included in the population data.

For example, in step S400 of FIG. 5, the semiconductor device analysis apparatus 100 may determine the weak design attribute among the plurality of design attributes and the weak value of the weak design attribute, which causes the outlier output values in the plurality of semiconductor devices 200-1, 200-2, . . . , 200-n, based on a difference between a ratio of a number of outlier output values, which are related with respective values of the plurality of design attributes, among the plurality of outlier output values included in the discriminated data to a total number of the plurality of outlier output values included in the discriminated data (which may be characterized as a first ratio), and a ratio of a number of output values, which are related with respective values of the plurality of design attributes, among the plurality of output values OV1, OV2, . . . , OVn included in the population data to a total number of the plurality of output values OV1, OV2, . . . , OVn included in the population data (which may be characterized as a second ratio).

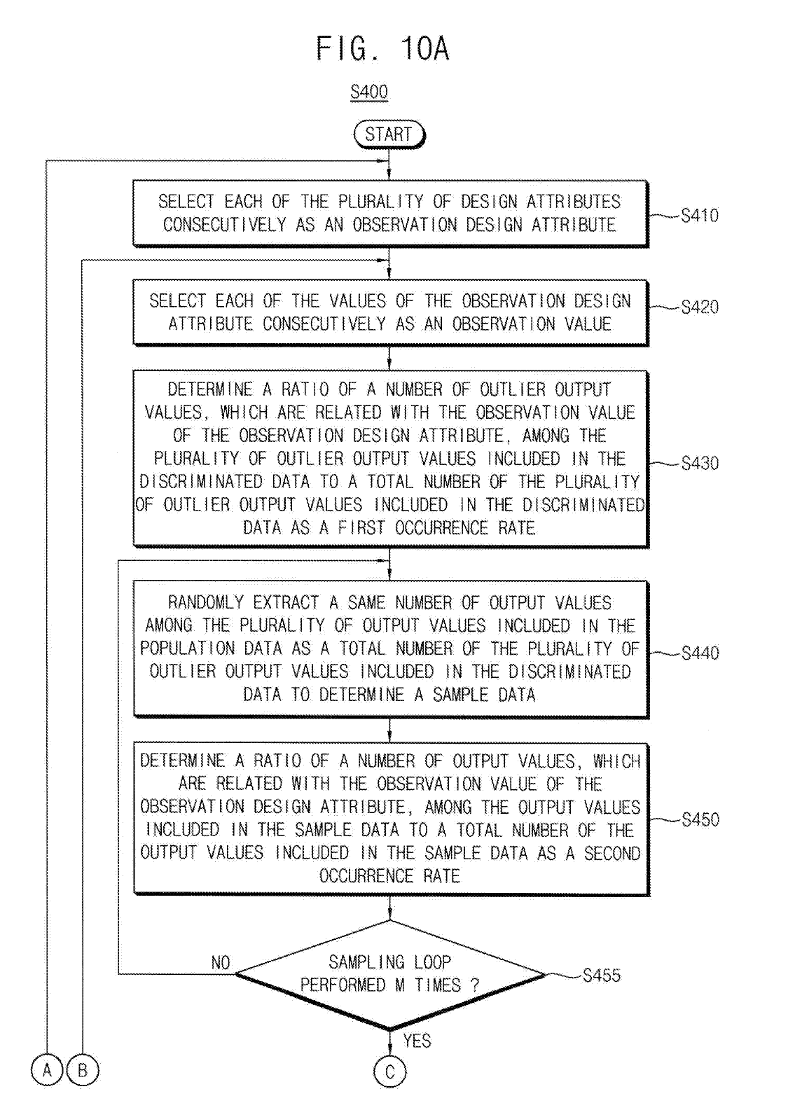

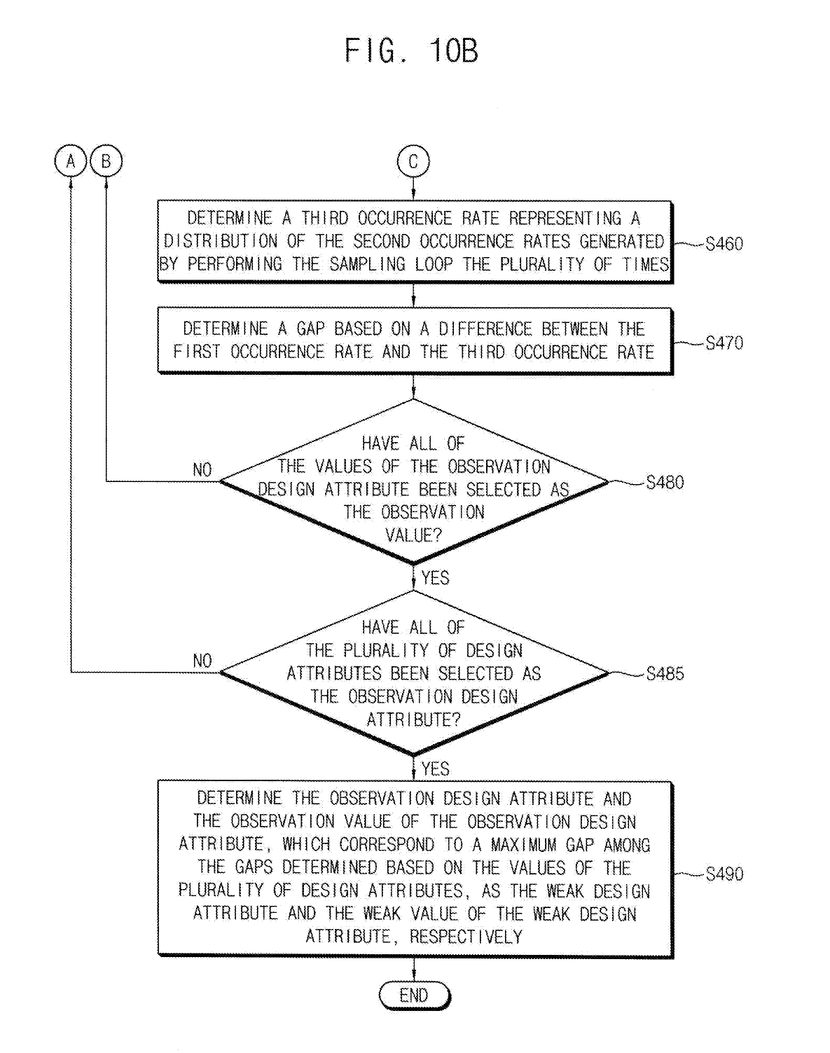

FIGS. 10A and 10B illustrate a flow chart of an example of a process of determining a weak design attribute and a weak value of the weak design attribute of FIG. 5.

Referring to FIGS. 10A and 10B, in step S410 the semiconductor device analysis apparatus 100 may select each of the plurality of design attributes consecutively as an observation design attribute in corresponding loops. For example, during a first loop through step S410 a first of the design attributes may be selected as an observation design attribute, and during a next loop through step S410 a next consecutive design attribute may be selected as an observation design attribute. In step S420, the semiconductor device analysis apparatus 100 may select each of the values of the observation design attribute consecutively as an observation value in corresponding loops. For example, during a first loop through step S420 a first value of the observation design attribute may be selected as an observation value, and during a next loop through step S420 a next consecutive value of the observation design attribute may be selected as an observation value. That is, in a corresponding loop through steps S410 and S420, the semiconductor device analysis apparatus 100 may select one of the plurality of design attributes as the observation design attribute, and may then select one of the values that the observation design attribute is able to have as the observation value.

After that, in step S430, the semiconductor device analysis apparatus 100 may determine a ratio (i.e., the first ratio) of a number of outlier output values, which are related with the observation value of the observation design attribute, among the plurality of outlier output values included in the discriminated data, to a total number of the plurality of outlier output values included in the discriminated data, as a first occurrence rate. Therefore, the first occurrence rate may represent a ratio in which the observation value of the observation design attribute is related with the plurality of outlier output values included in the discriminated data.

In addition, in step S440 the semiconductor device analysis apparatus 100 may randomly extract a same number of output values among the plurality of output values OV1, OV2, . . . , OVn included in the population data as a total number of the plurality of outlier output values included in the discriminated data to determine a sample data. In step S450 the semiconductor device analysis apparatus 100 may determine a ratio (i.e., the second ratio) of a number of output values, which are related with the observation value of the observation design attribute, among the output values included in the sample data, to a total number of the output values included in the sample data, as a second occurrence rate.

As illustrated in FIGS. 10A and 10B, the semiconductor device analysis apparatus 100 may perform a sampling loop, which includes randomly determining the sample data based on the population data (step S440) and determining the second occurrence rate based on the sample data (step S450), M times (step S455). Upon determination by the semiconductor device analysis apparatus 100 that the sampling loop has not been performed M times (no in step S455), processing proceeds to step S440 so that another sampling loop may be performed. Upon determination by the semiconductor device analysis apparatus 100 that the sampling loop has been performed M times (yes in step S455), processing proceeds to step S460, which will be subsequently described. Here, M represents a positive integer.

Although FIGS. 10A and 10B represent that the semiconductor device analysis apparatus 100 performs the sampling loop M times after determining the first occurrence rate, embodiments of the inventive concept are not limited thereto. In other embodiments, the semiconductor device analysis apparatus 100 may determine the first occurrence rate after performing the sampling loop M times, or may determine the first occurrence rate simultaneously with performing the sampling loop M times.

After that, in step S460, the semiconductor device analysis apparatus 100 may determine a third occurrence rate representing the distribution of the second occurrence rates generated by performing the sampling loop M times. Therefore, the third occurrence rate may represent a ratio in which the observation value of the observation design attribute is related with the plurality of output values OV1, OV2, . . . , OVn included in the population data. As the number of times of performing the sampling loop increases, the third occurrence rate may more correctly represent the ratio in which the observation value of the observation design attribute is related with the plurality of output values OV1, OV2, . . . , OVn included in the population data.

In some embodiments of the inventive concept, the semiconductor device analysis apparatus 100 may determine an average value of the distribution of the second occurrence rates as the third occurrence rate. In other embodiments, the semiconductor device analysis apparatus 100 may determine a most frequent value of the distribution of the second occurrence rates as the third occurrence rate. However, embodiments of the inventive concept are not limited to determining the third occurrence rate as here described. In still further embodiments, the semiconductor device analysis apparatus 100 may determine the third occurrence rate representing the distribution of the second occurrence rates using various methods.

After that, in step S470, the semiconductor device analysis apparatus 100 may determine a gap based on a difference between the first occurrence rate and the third occurrence rate.

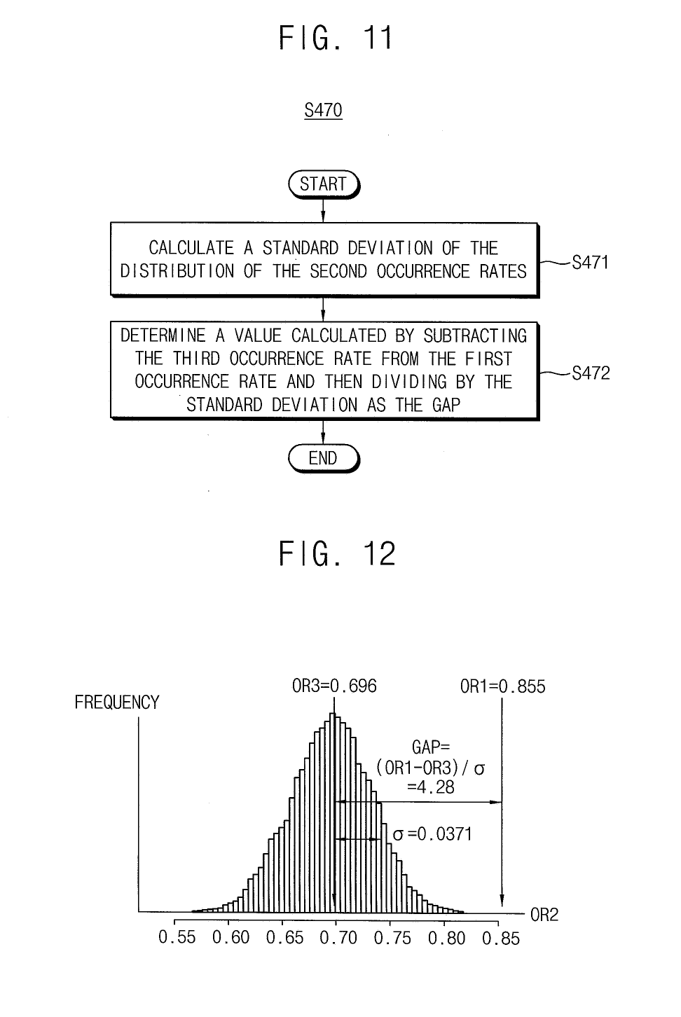

FIG. 11 illustrates a flow chart of an example of a process of determining a gap based on a difference between a first occurrence rate and a third occurrence rate of FIGS. 10A and 10B.

Referring to FIG. 11, in step S471 the semiconductor device analysis apparatus 100 may calculate a standard deviation of the distribution of the second occurrence rates. In step S472 the semiconductor device analysis apparatus 100 may determine a value calculated by subtracting the third occurrence rate from the first occurrence rate, and then dividing the difference by the standard deviation, as the gap.

FIG. 12 illustrates a diagram for describing the process of determining a gap based on a difference between a first occurrence rate and a third occurrence rate of FIG. 11.

A frequency histogram representing the distribution of the second occurrence rates OR2 generated by performing the sampling loop M times is illustrated in FIG. 12. In FIG. 12, an x-axis may represent values of the second occurrence rates OR2 and a y-axis may represent frequency (i.e., the number of times each value of the second occurrence rate occurs).

In the frequency histogram of FIG. 12, as an example, the first occurrence rate OR1 which represents a ratio in which the observation value of the observation design attribute is related with the plurality of outlier output values included in the discriminated data corresponds to 0.855, the third occurrence rate OR3 which represents a ratio in which the observation value of the observation design attribute is related with the plurality of output values OV1, OV2, . . . , OVn included in the population data corresponds to 0.696, and the standard deviation of the distribution of the second occurrence rates OR2 corresponds to 0.0371.

In the case of this example as illustrated in FIG. 12, the semiconductor device analysis apparatus 100 may determine a value of 4.28 calculated by subtracting the third occurrence rate OR3 from the first occurrence rate OR1, and then dividing the difference by the standard deviation, as the gap corresponding to the observation value of the observation design attribute.

Therefore, the gap may represent how much the first occurrence rate OR1, which represents a ratio in which the observation value of the observation design attribute is related with the plurality of outlier output values included in the discriminated data, is greater than the third occurrence rate OR3, which represents a ratio in which the observation value of the observation design attribute is related with the plurality of output values OV1, OV2, . . . , OVn included in the population data.

As the gap increases with a positive value, a probability that the observation value of the observation design attribute is related with the plurality of outlier output values included in the discriminated data may be greater than a probability that the observation value of the observation design attribute is related with the plurality of output values OV1, OV2, . . . , OVn included in the population data. On the other hand, when the gap has a negative value, a probability that the observation value of the observation design attribute is related with the plurality of outlier output values included in the discriminated data may be smaller than a probability that the observation value of the observation design attribute is related with the plurality of output values OV1, OV2, . . . , OVn included in the population data.

In some embodiments of the inventive concept, the semiconductor device analysis apparatus 100 may calculate a p-value of the first occurrence rate OR1 in the distribution of the second occurrence rates OR2. For example, the semiconductor device analysis apparatus 100 may determine a probability that a second occurrence rate OR2 is greater than the first occurrence rate OR1 as the p-value of the first occurrence rate OR1.

In this case, as the p-value approaches zero, the probability that the observation value of the observation design attribute is related with the plurality of outlier output values included in the discriminated data may be greater than the probability that the observation value of the observation design attribute is related with the plurality of output values OV1, OV2, . . . , OVn included in the population data.

Referring again to FIGS. 10A and 10B, after the semiconductor device analysis apparatus 100 determines the gap corresponding to the observation value of the observation design attribute in step S470, the semiconductor device analysis apparatus 100 in step S480 may determine whether all of the values that the observation design attribute is able to be have been selected as the observation value.

When all of the values that the observation design attribute is able to be have not been selected as the observation value (no in step S480), the semiconductor device analysis apparatus 100 may in step S420 select another of the values that the observation design attribute is able to have as a new observation value.

After that, the semiconductor device analysis apparatus 100 may determine the gap corresponding to the new observation value of the observation design attribute by performing the steps S430, S440, S450, S455, S460, and S470.

When all of the values that the observation design attribute is able to be have been selected as the observation value (yes in step S480), the semiconductor device analysis apparatus 100 may in step S485 determine whether all of the plurality of design attributes have been selected as the observation design attribute.

When all of the plurality of design attributes have not been selected as the observation design attribute (no in step S485), the semiconductor device analysis apparatus 100 may select another of the plurality of design attributes as a new observation design attribute in step S410.

After that, the semiconductor device analysis apparatus 100 may determine the gap corresponding to each of the values that the new observation design attribute is able to have by performing the steps S420, S430, S440, S450, S455, S460, S470, and S480.

When all of the plurality of design attributes have been selected as the observation design attribute (yes in step S485), the semiconductor device analysis apparatus 100 may in step S490 determine the observation design attribute and the observation value of the observation design attribute, which correspond to a maximum gap among the gaps determined based on the values of the plurality of design attributes, respectively as the weak design attribute and the weak value of the weak design attribute.

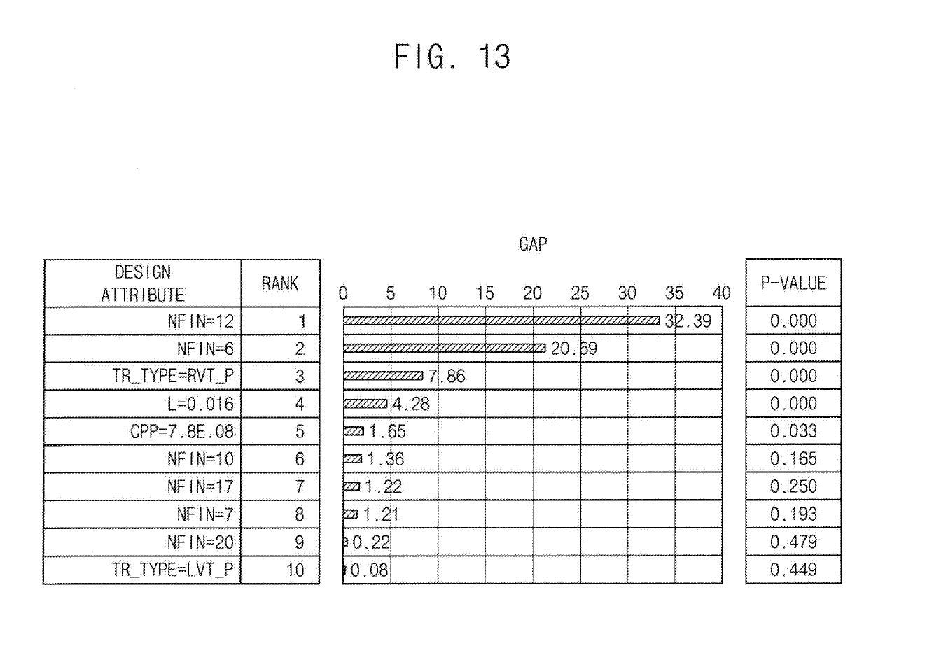

FIG. 13 illustrates a diagram for describing the process of determining a weak design attribute and a weak value of the weak design attribute of FIGS. 10A and 10B.

FIG. 13 represents gaps determined based on the values of the plurality of design attributes as an example, whereby each of the plurality of semiconductor devices 200-1, 200-2, . . . , 200-n corresponds to a transistor, each of the plurality of output values OV1, OV2, . . . , OVn corresponds to a magnitude of a drain current of each of the plurality of semiconductor devices 200-1, 200-2, . . . , 200-n in a saturation state, and output values, which have a relatively small magnitude, among the plurality of output values OV1, OV2, . . . , OVn included in the population data are determined as the plurality of outlier output values.

In FIG. 13, the design attribute L may represent a gate length of each of the plurality of semiconductor devices 200-1, 200-2, . . . , 200-n in a unit of micro meter, and the design attribute CPP may represent a distance between gates of adjacent semiconductor devices 200-1, 200-2, . . . , 200-n in a unit of meter.

In the example of FIG. 13, the gap which corresponds to a case in which the number of fins (NFIN) of the semiconductor device manufactured by a fin field effect transistor (FinFET) process is 12 is the greatest among the gaps for the values of the plurality of design attributes.

Therefore, the semiconductor device analysis apparatus 100 may determine the design attribute NFIN, which represents the number of fins of the semiconductor device, among the plurality of design attributes as the weak design attribute, and may determine 12 as the weak value of the weak design attribute.

As described above with reference to FIGS. 1 to 13, the semiconductor device analysis apparatus 100 according to embodiments of the inventive concept may determine the weak design attribute and the weak value of the weak design attribute which causes the outlier output values in the plurality of semiconductor devices 200-1, 200-2, . . . , 200-n effectively and correctly based on the plurality of output values OV1, OV2, . . . , OVn measured from the plurality of semiconductor devices 200-1, 200-2, . . . , 200-n, which are manufactured based on various values of the plurality of design attributes.

After that, a yield of the semiconductor chip 310 may be increased by eliminating the weak value of the weak design attribute when designing a circuit of the semiconductor chip 310.

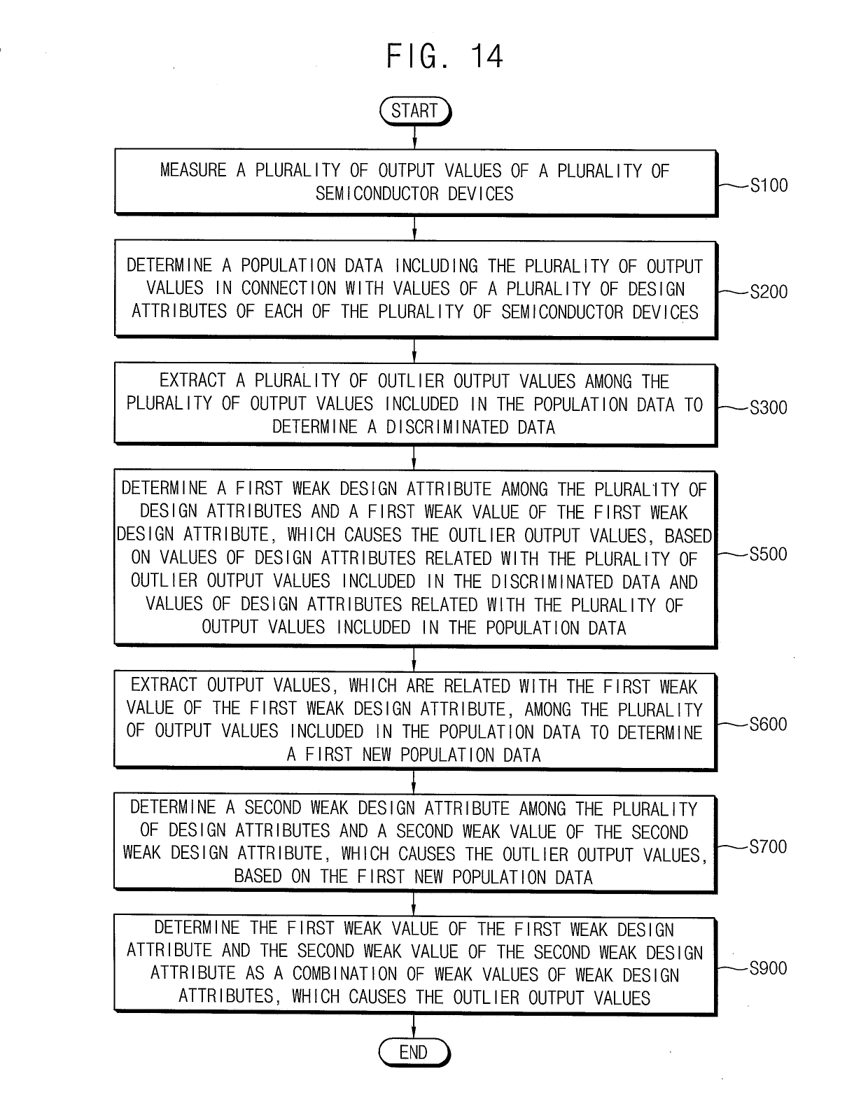

FIG. 14 illustrates a flow chart of a method of analyzing a semiconductor device according to example embodiments.

The method of analyzing a semiconductor device of FIG. 14 may be performed by the semiconductor device analysis apparatus 100 included in the semiconductor device analysis system 10 of FIG. 1. Hereinafter, the method of analyzing a semiconductor device performed by the semiconductor device analysis apparatus 100 will be described with reference to FIGS. 1 to 14.

Referring to FIG. 14, in step S100 the semiconductor device analysis apparatus 100 may measure the plurality of output values OV1, OV2, . . . , OVn of the plurality of semiconductor devices 200-1, 200-2, . . . , 200-n.

For example, the semiconductor device analysis apparatus 100 (i.e., measurement device 110) may provide the control signals CONs to each of the plurality of semiconductor devices 200-1, 200-2, . . . , 200-n, and may measure the plurality of output values OV1, OV2, . . . , OVn generated by the plurality of semiconductor devices 200-1, 200-2, . . . , 200-n based on the control signals CONs.

In step S200, the semiconductor device analysis apparatus 100 (i.e., analysis device 130) may determine the population data including the plurality of output values OV1, OV2, . . . , OVn, which are measured from the plurality of semiconductor devices 200-1, 200-2, . . . , 200-n, in connection with the values DAVs1, DAVs2, . . . , DAVsn of the plurality of design attributes of each of the plurality of semiconductor devices 200-1, 200-2, . . . , 200-n.

That is, for example, the k-th output value OVk measured from the k-th semiconductor device 200-k may be connected with the values DAVsk of the plurality of design attributes of the k-th semiconductor device 200-k in the population data. That is, in other words, in the population data the k-th output value OVk measured from the k-th semiconductor device 200-k may be grouped or paired as related to or corresponding with the values DAVsk of the plurality of design attributes of the k-th semiconductor device 200-k.

After that in step S300, the semiconductor device analysis apparatus 100 may extract the plurality of outlier output values, which have abnormal values, among the plurality of output values OV1, OV2, . . . , OVn included in the population data to determine the discriminated data.

In some embodiments of the inventive concept, the semiconductor device analysis apparatus 100 (i.e., analysis device 130) may extract the plurality of outlier output values among the plurality of output values OV1, OV2, . . . , OVn included in the population data based on a difference between each of the plurality of output values OV1, OV2, . . . , OVn included in the population data and an average value of the plurality of output values OV1, OV2, . . . , OVn included in the population data, to determine the discriminated data. For example, the semiconductor device analysis apparatus 100 may extract output values, which have a great difference from the average value of the plurality of output values OV1, OV2, . . . , OVn, among the plurality of output values OV1, OV2, . . . , OVn included in the population data as the plurality of outlier output values, and determine the plurality of outlier output values as the discriminated data.

The semiconductor device analysis apparatus 100 may extract the plurality of outlier output values among the plurality of output values OV1, OV2, . . . , OVn included in the population data to determine the discriminated data using the methods described above with reference to FIGS. 6 to 9. However, embodiments of the inventive concept are not limited to the extraction as described with respect to FIGS. 6-9. In other embodiments, the semiconductor device analysis apparatus 100 may extract output values, which have a great difference from the average value of the plurality of output values OV1, OV2, . . . , OVn, among the plurality of output values OV1, OV2, . . . , OVn included in the population data as the plurality of outlier output values using various methods, and determine the plurality of outlier output values as the discriminated data.

After that in step S500, the semiconductor device analysis apparatus 100 may determine a first weak design attribute among the plurality of design attributes and a first weak value of the first weak design attribute, which causes the outlier output values in the plurality of semiconductor devices 200-1, 200-2, . . . , 200-n, based on values of design attributes related with the plurality of outlier output values included in the discriminated data and values of design attributes related with the plurality of output values OV1, OV2, . . . , OVn included in the population data.

For example, the semiconductor device analysis apparatus 100 may determine the first weak design attribute among the plurality of design attributes and the first weak value of the first weak design attribute, which causes the outlier output values in the plurality of semiconductor devices 200-1, 200-2, . . . , 200-n, based on a difference between a ratio of a number of outlier output values, which are related with respective values of the plurality of design attributes, among the plurality of outlier output values included in the discriminated data to a total number of the plurality of outlier output values included in the discriminated data, and a ratio of a number of output values, which are related with respective values of the plurality of design attributes, among the plurality of output values OV1, OV2, . . . , OVn included in the population data to a total number of the plurality of output values OV1, OV2, . . . , OVn included in the population data.

Therefore, the first weak value of the first weak design attribute may represent a value of a design attribute, which has a highest probability to cause the outlier output values in the plurality of semiconductor devices 200-1, 200-2, . . . , 200-n, among the values of the plurality of design attributes.

In some embodiments of the inventive concept, the semiconductor device analysis apparatus 100 may determine the first weak design attribute and the first weak value of the first weak design attribute based on the population data and the discriminated data in step S500 of FIG. 14 using the same method of determining the weak design attribute and the weak value of the weak design attribute based on the population data and the discriminated data as described with respect to FIGS. 10A and 10B.

The method of determining the weak design attribute and the weak value of the weak design attribute based on the population data and the discriminated data of FIGS. 10A and 10B has been described above with reference to FIGS. 10A, 10B, 11, 12, and 13. Therefore, further detailed description of determining the first weak design attribute and the first weak value of the first weak design attribute based on the population data and the discriminated data of step S500 of FIG. 14 will be omitted for brevity.

However, embodiments of the inventive concept are not limited to determining the first weak design attribute and the first weak value of the first weak design attribute as described above. According to other embodiments of the inventive concept, the semiconductor device analysis apparatus 100 may determine the first weak design attribute among the plurality of design attributes and the first weak value of the first weak design attribute, which causes the outlier output values in the plurality of semiconductor devices 200-1, 200-2, . . . , 200-n, using various methods.

After that in step S600, the semiconductor device analysis apparatus 100 may extract output values, which are related with the first weak value of the first weak design attribute, among the plurality of output values OV1, OV2, . . . , OVn included in the population data to determine a first new population data. Outlier output values, which are related with the first weak value of the first weak design attribute, among the plurality of outlier output values included in the population data may be also included in the first new population data.

Therefore, all of the output values included in the first new population data may be related with the first weak value of the first weak design attribute.

After that in step S700, the semiconductor device analysis apparatus 100 may determine a second weak design attribute among the plurality of design attributes and a second weak value of the second weak design attribute, which causes the outlier output values in the plurality of semiconductor devices 200-1, 200-2, . . . , 200-n, based on the first new population data.

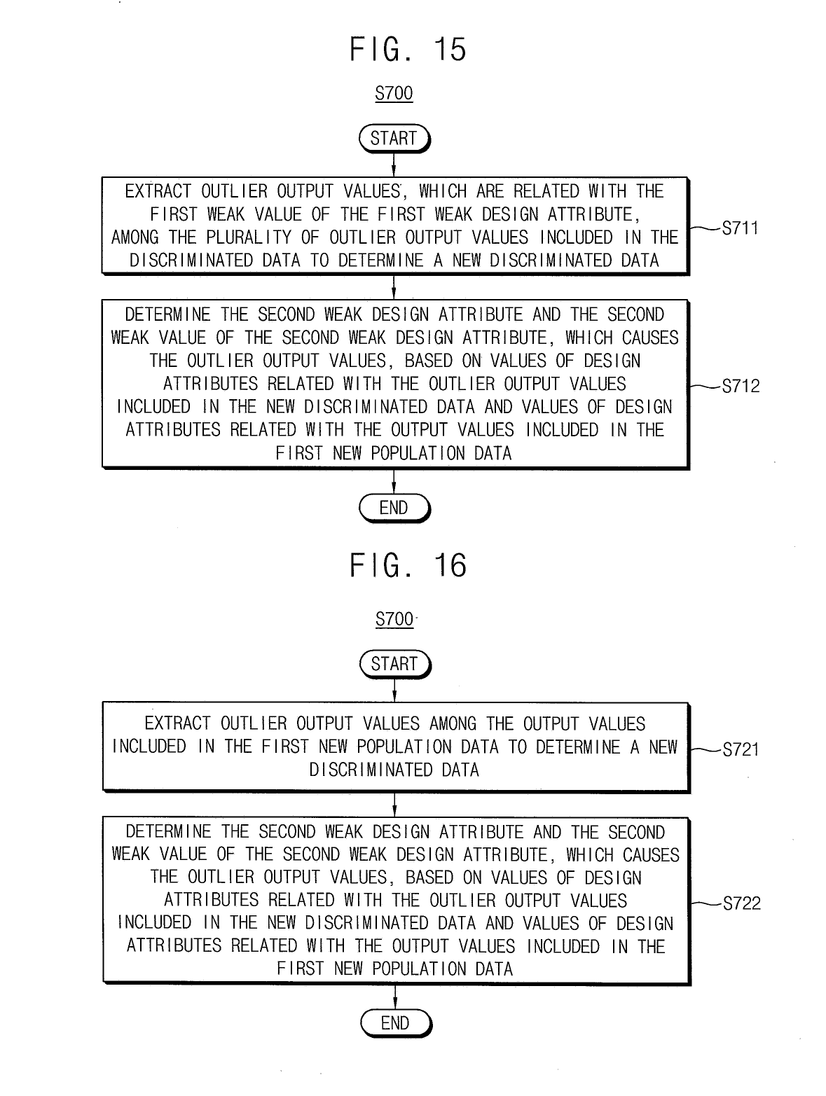

FIG. 15 illustrates a flow chart of an example of a process of determining a second weak design attribute and a second weak value of the second weak design attribute of FIG. 14.

Referring to FIG. 15, the semiconductor device analysis apparatus 100 in step S711 may extract outlier output values, which are related with the first weak value of the first weak design attribute, among the plurality of outlier output values included in the discriminated data to determine a new discriminated data. That is, the semiconductor device analysis apparatus 100 may extract outlier output values, which are related with the first weak value of the first weak design attribute, among the plurality of outlier output values included in the discriminated data, which is generated through the step S300, to determine the new discriminated data.

After that in step S712, the semiconductor device analysis apparatus 100 may determine the second weak design attribute and the second weak value of the second weak design attribute, which causes the outlier output values in the plurality of semiconductor devices 200-1, 200-2, . . . , 200-n, based on values of design attributes related with the outlier output values included in the new discriminated data and values of design attributes related with the output values included in the first new population data.

For example, the semiconductor device analysis apparatus 100 in step S712 may determine the second weak design attribute and the second weak value of the second weak design attribute based on the first new population data and the new discriminated data using the same method of determining the first weak design attribute and the first weak value of the first weak design attribute based on the population data and the discriminated data as in step S500.

FIG. 16 illustrates a flow chart of another example of a process of determining a second weak design attribute and a second weak value of the second weak design attribute of FIG. 14.

Referring to FIG. 16, the semiconductor device analysis apparatus 100 in step S721 may extract outlier output values among the output values included in the first new population data to determine a new discriminated data. That is, the semiconductor device analysis apparatus 100 may generate the new discriminated data based on the first new population data without using the discriminated data generated in step S300 of FIG. 14.

After that in step S722, the semiconductor device analysis apparatus 100 may determine the second weak design attribute and the second weak value of the second weak design attribute, which causes the outlier output values in the plurality of semiconductor devices 200-1, 200-2, . . . , 200-n, based on values of design attributes related with the outlier output values included in the new discriminated data and values of design attributes related with the output values included in the first new population data.

For example, the semiconductor device analysis apparatus 100 in step S722 may determine the second weak design attribute and the second weak value of the second weak design attribute based on the first new population data and the new discriminated data using the same method of determining the first weak design attribute and the first weak value of the first weak design attribute based on the population data and the discriminated data as in step S500.

Therefore, the second weak value of the second weak design attribute may represent a value of a design attribute, which has a highest probability to cause the outlier output values in the semiconductor devices related with the first weak value of the first weak design attribute among the plurality of semiconductor devices 200-1, 200-2, . . . , 200-n, among the values of the plurality of design attributes.

Referring again to FIG. 14, the semiconductor device analysis apparatus 100 in step S900 may determine the first weak value of the first weak design attribute and the second weak value of the second weak design attribute as a combination of weak values of weak design attributes, which causes the outlier output values in the plurality of semiconductor devices 200-1, 200-2, . . . , 200-n.

As described above with reference to FIGS. 1 to 16, the semiconductor device analysis apparatus 100 according to embodiments of the inventive concept may determine the combination of weak values of weak design attributes which has a high probability to cause the outlier output values in the plurality of semiconductor devices 200-1, 200-2, . . . , 200-n effectively and correctly based on the plurality of output values OV1, OV2, . . . , OVn measured from the plurality of semiconductor devices 200-1, 200-2, . . . , 200-n, which are manufactured based on various values of the plurality of design attributes.

After that, a yield of the semiconductor chip 310 may be increased by eliminating the combination of weak values of weak design attributes when designing a circuit of the semiconductor chip 310.

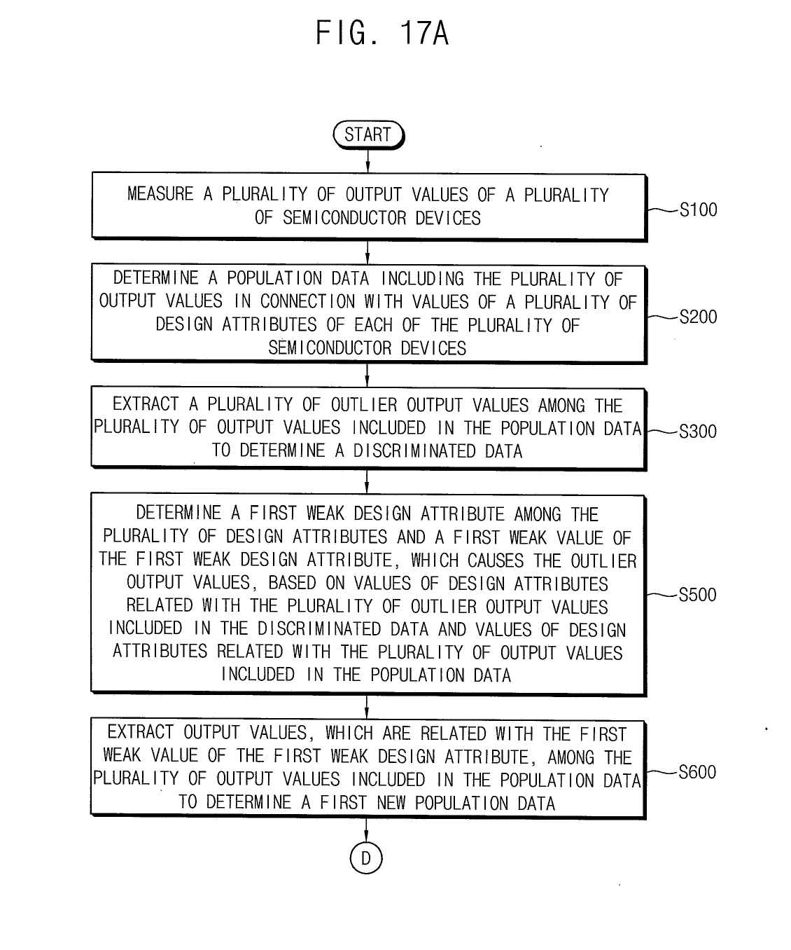

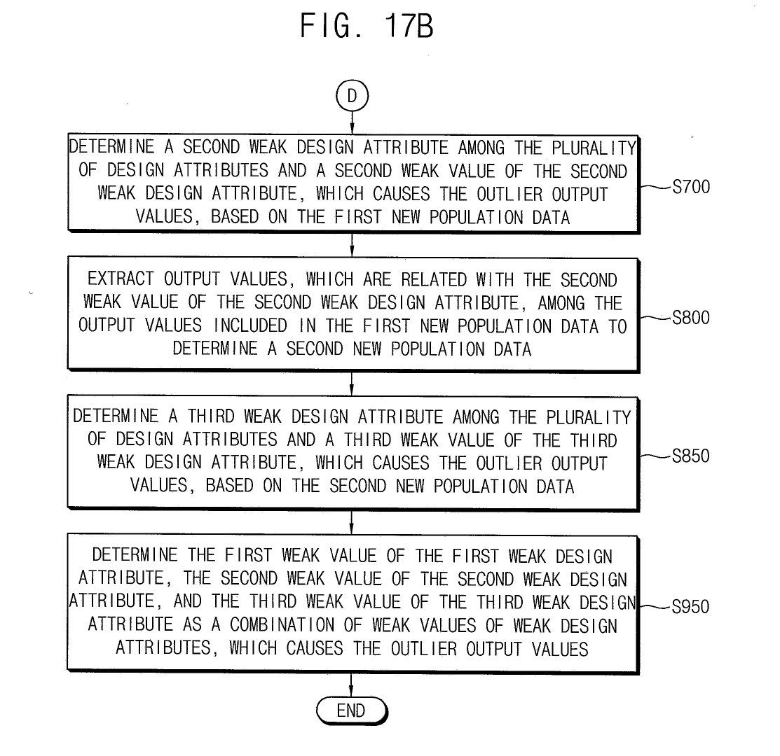

FIGS. 17A and 17B illustrate a flow chart of a method of analyzing a semiconductor device according to embodiments of the inventive concept.

The method of analyzing a semiconductor device of FIGS. 17A and 17B may be performed by the semiconductor device analysis apparatus 100 included in the semiconductor device analysis system 10 of FIG. 1.

The method of analyzing a semiconductor device of FIGS. 17A and 17B may be considered as corresponding to an extension of the method of analyzing a semiconductor device as described with respect to FIG. 14. That is, steps S100 to S700 in FIGS. 17A and 17B respectively correspond and are the same as steps S100 to S700 shown in FIG. 14. The following description will therefore focus on the differences between the embodiments shown in FIG. 14 and FIGS. 17A and 17B, and description of steps S100 to S700 in FIGS. 17A and 17B will be omitted for brevity.

Referring to FIGS. 17A and 17B, after the semiconductor device analysis apparatus 100 determines the second weak design attribute and the second weak value of the second weak design attribute, which causes the outlier output values in the plurality of semiconductor devices 200-1, 200-2, . . . , 200-n, based on the first new population data in step S700, the semiconductor device analysis apparatus 100 may in step S800 extract output values, which are related with the second weak value of the second weak design attribute, among the output values included in the first new population data to determine a second new population data. Outlier output values, which are related with the second weak value of the second weak design attribute, among the outlier output values included in the first new population data may be also included in the second new population data.

Therefore, all of the output values included in the second new population data may be related with the second weak value of the second weak design attribute.

After that in step S850, the semiconductor device analysis apparatus 100 may determine a third weak design attribute among the plurality of design attributes and a third weak value of the third weak design attribute, which causes the outlier output values in the plurality of semiconductor devices 200-1, 200-2, . . . , 200-n, based on the second new population data.

In some embodiments of the inventive concept, the semiconductor device analysis apparatus 100 may determine the third weak design attribute and the third weak value of the third weak design attribute based on the second new population data using the same method of determining the second weak design attribute and the second weak value of the second weak design attribute based on the first new population data as described with respect to step S700 in FIG. 17B.

After that in step S950, the semiconductor device analysis apparatus 100 may determine the first weak value of the first weak design attribute, the second weak value of the second weak design attribute, and the third weak value of the third weak design attribute as a combination of weak values of weak design attributes, which causes the outlier output values in the plurality of semiconductor devices 200-1, 200-2, . . . , 200-n.

According to embodiments of the inventive concept, the semiconductor device analysis apparatus 100 may determine a combination of weak values of weak design attributes including further levels by repeating an operation loop, which includes operations corresponding to steps S800 and S850, a plurality of times until a loop finish condition is established.

In some embodiments of the inventive concept, the semiconductor device analysis apparatus 100 may determine that the loop finish condition is established and may finish the operation loop when all of output values included in a new population data, which is newly generated when performing the operation loop every time, have a unique value for each of the plurality of design attributes or when the operation loop is performed a predetermined number of times. In other embodiments of the inventive concept, the semiconductor device analysis apparatus 100 may determine that the loop finish condition is established to finish the operation loop when the p-value of the first occurrence rate OR1 for each of the plurality of design attributes, which is calculated when performing the operation loop every time, is greater than a threshold value.

In accordance with these embodiments of the inventive concept, the semiconductor device analysis apparatus 100 may determine the weak values of the weak design attributes, which are determined until the operation loop is finished, as a combination of weak values of weak design attributes, which causes the outlier output values in the plurality of semiconductor devices 200-1, 200-2, . . . , 200-n (step S950).

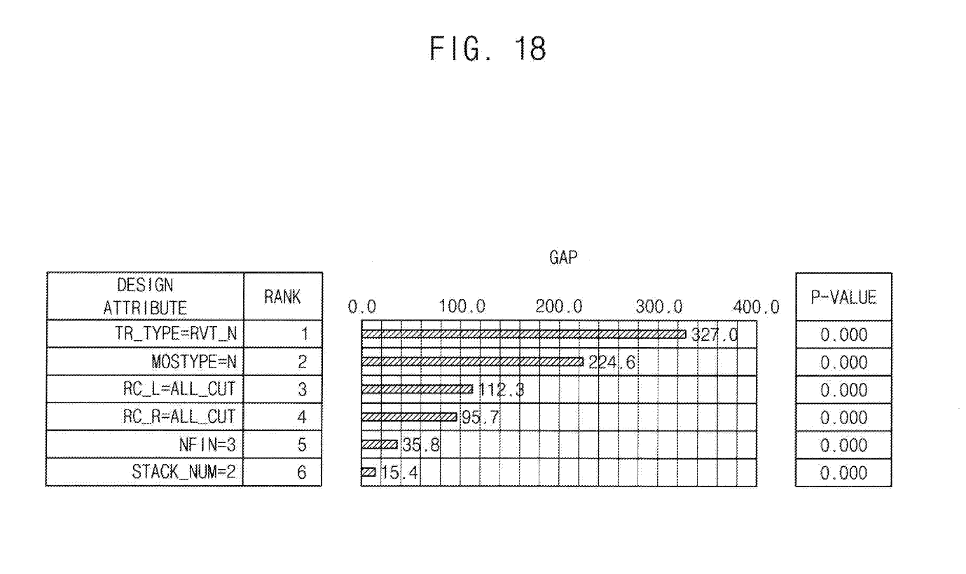

FIGS. 18 to 23 illustrate diagrams for describing the method of analyzing a semiconductor device of FIGS. 17A and 17B.

FIGS. 18 to 23 represent the gaps determined based on the values of the plurality of design attributes as an example when each of the plurality of semiconductor devices 200-1, 200-2, . . . , 200-n corresponds to a transistor, each of the plurality of output values OV1, OV2, . . . , OVn corresponds to a magnitude of a drain current of each of the plurality of semiconductor devices 200-1, 200-2, . . . , 200-n in a saturation state, and output values, which have a relatively small magnitude, are determined as the outlier output values.

In FIGS. 18 to 23, the design attribute MOSTYPE may represent whether each of the plurality of semiconductor devices 200-1, 200-2, . . . , 200-n is an n-type transistor or a p-type transistor. For example, a semiconductor device may correspond to an n-type transistor when the design attribute MOSTYPE of the semiconductor device has a first value N, and a semiconductor device may correspond to a p-type transistor when the design attribute MOSTYPE of the semiconductor device has a second value P. In addition, the design attribute STACK_NUM may represent a number of gates stacked on each other.

FIG. 18 represents the gaps corresponding to the values of the design attributes generated by performing operations of FIGS. 17A and 17B based on the population data.

In an example of FIG. 18, the gap, which corresponds to a case in which the semiconductor device corresponds to an n-type transistor having a regular threshold voltage, is the greatest among the gaps for the values of the design attributes.

Therefore, the semiconductor device analysis apparatus 100 may determine the design attribute TR_TYPE, which represents a transistor type and a magnitude of a threshold voltage, as the first weak design attribute, and may determine the value RVT_N as the first weak value of the first weak design attribute. This determination may for example be considered as corresponding to a step such as step S500 in FIG. 17A.

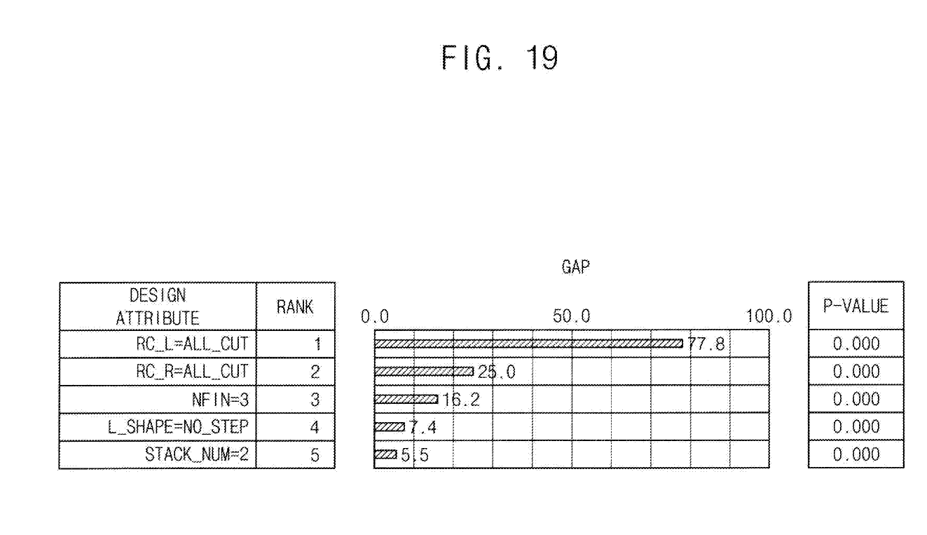

FIG. 19 represents the gaps corresponding to the values of the design attributes generated by performing operations of FIGS. 17A and 17B based on the first new population data, which is generated by extracting output values related with the first weak value of the first weak design attribute among the output values included in the population data. This extraction may for example be considered as corresponding to a step such as step S600 in FIG. 17A.

In an example of FIG. 19, the gap, which corresponds to a case in which all portions of a left active region of the semiconductor device is cut by a shallow trench, is the greatest among the gaps for the values of the design attributes.

Therefore, the semiconductor device analysis apparatus 100 may determine the design attribute RC_L, which represents whether a left active region of each of the plurality of semiconductor devices 200-1, 200-2, . . . , 200-n is cut by a shallow trench, as the second weak design attribute, and may determine the value ALL_CUT as the second weak value of the second weak design attribute. This determination may for example be considered as corresponding to a step such as step S700 in FIG. 17B.

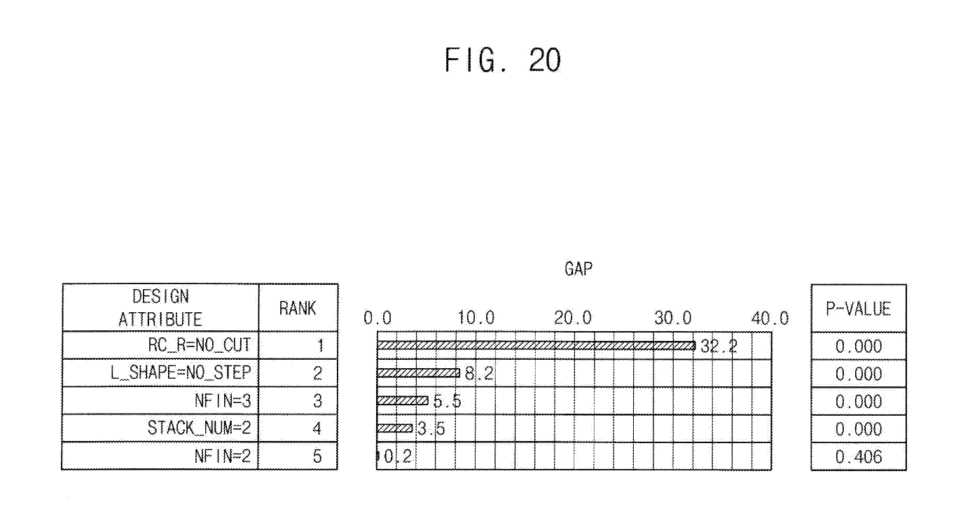

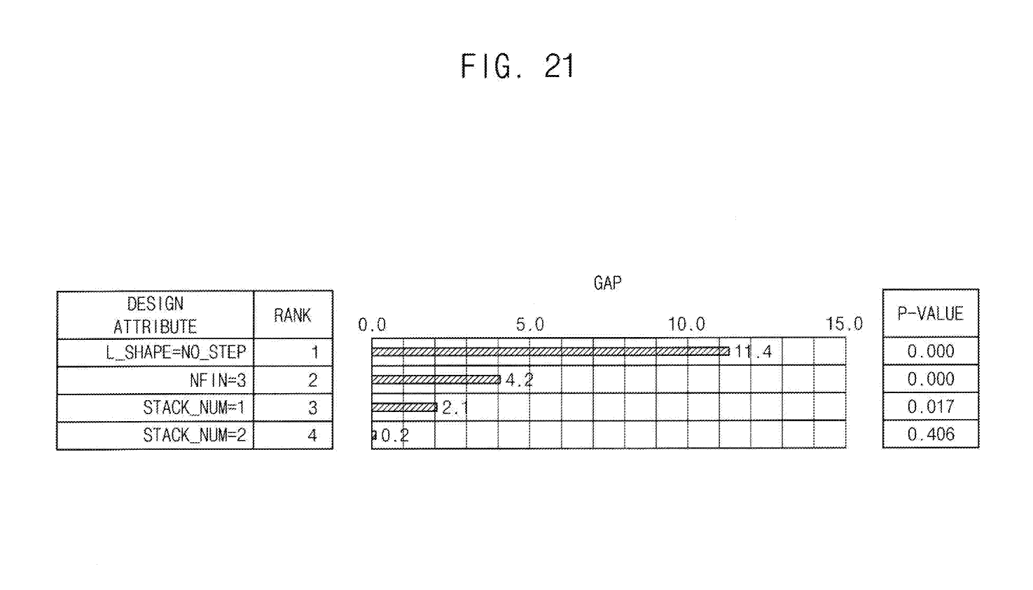

FIG. 20 represents the gaps corresponding to the values of the design attributes generated by performing operations of FIGS. 17A and 17B based on the second new population data, which is generated by extracting output values related with the second weak value of the second weak design attribute among the output values included in the first new population data. This extraction may for example be considered as corresponding to a step such as step S800 in FIG. 17B.

In an example of FIG. 20, the gap, which corresponds to a case in which no portion of a right active region of the semiconductor device is cut by a shallow trench, is the greatest among the gaps for the values of the design attributes.

Therefore, the semiconductor device analysis apparatus 100 may determine the design attribute RC_R, which represents whether a right active region of each of the plurality of semiconductor devices 200-1, 200-2, . . . , 200-n is cut by a shallow trench, as the third weak design attribute, and may determine the value NO_CUT as the third weak value of the third weak design attribute. This determination may for example be considered as corresponding to a step such as step S850 in FIG. 17B.

FIG. 21 represents the gaps corresponding to the values of the design attributes generated by performing operations of FIGS. 17A and 17B based on a third new population data, which is generated by extracting output values related with the third weak value of the third weak design attribute among the output values included in the second new population data. This extraction may for example be considered as similar to another step such as step S800 in FIG. 17B, but however where the third new population is determined.

In an example of FIG. 21, the gap, which corresponds to a case in which a difference between a number of fins of a corresponding semiconductor device and a number of fins of an adjacent semiconductor device is zero when the plurality of semiconductor devices 200-1, 200-2, . . . , 200-n are manufactured by a fin field effect transistor (FinFET) process, is the greatest among the gaps for the values of the design attributes.

Therefore, the semiconductor device analysis apparatus 100 may determine the design attribute L_SHAPE, which represents a difference between a number of fins of a corresponding semiconductor device and a number of fins of an adjacent semiconductor device, as a fourth weak design attribute, and may determine the value NO_STEP as a fourth weak value of the fourth weak design attribute. This determination may for example be considered as similar to another step such as step S850 in FIG. 17B, but however based on the third new population data.

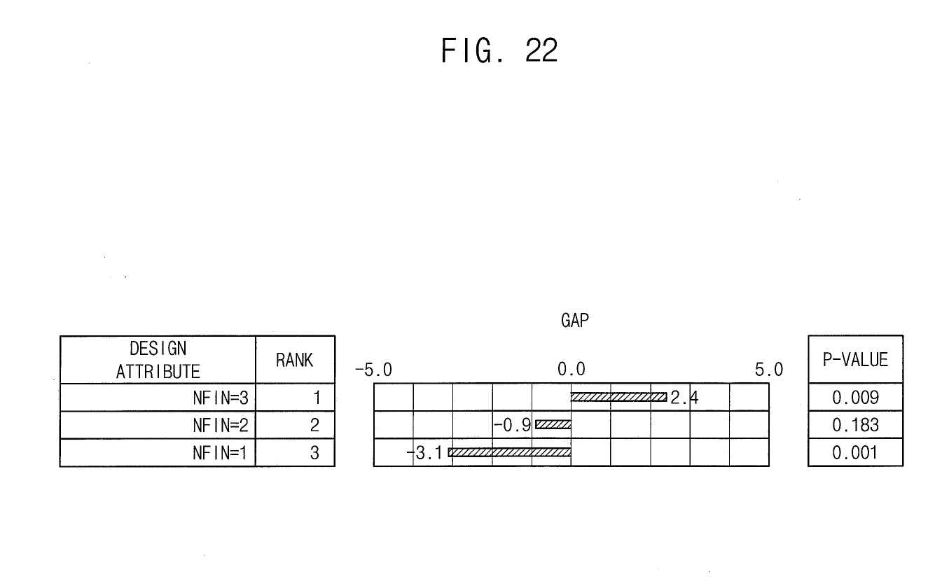

FIG. 22 represents the gaps corresponding to the values of the design attributes generated by performing operations of FIGS. 17A and 17B based on a fourth new population data, which is generated by extracting output values related with the fourth weak value of the fourth weak design attribute among the output values included in the third new population data. This extraction may for example be considered as similar to another step such as step S800 in FIG. 17B.

In an example of FIG. 22, the gap, which corresponds to a case in which a number of fins of the semiconductor device is three when the plurality of semiconductor devices 200-1, 200-2, . . . , 200-n are manufactured by a fin field effect transistor (FinFET) process, is the greatest among the gaps for the values of the design attributes.

Therefore, the semiconductor device analysis apparatus 100 may determine the design attribute NFIN, which represents a number of fins of each of the plurality of semiconductor devices 200-1, 200-2, . . . , 200-n, as a fifth weak design attribute, and determine three as a fifth weak value of the fifth weak design attribute. This determination may for example be considered as similar to another step such as step S850 in FIG. 17B. Of note, the repeating of steps S800 and S850 corresponds to the aforementioned operation loop described with respect to FIG. 17B.

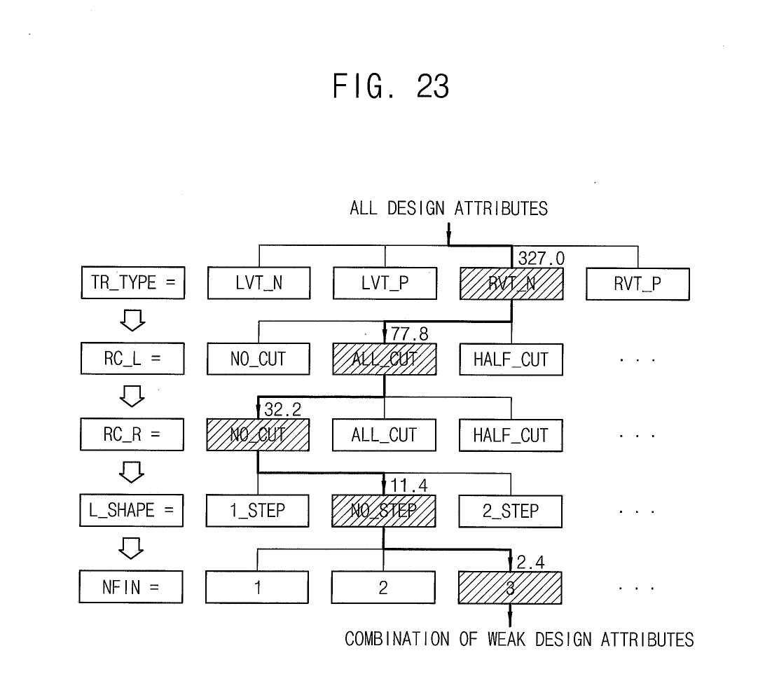

FIG. 23 represents a combination of the weak values of the weak design attributes, which are determined by the operations described above with reference to FIGS. 18 to 22.

As illustrated in FIG. 23, in an example of FIGS. 18 to 22, the semiconductor device analysis apparatus 100 may determine that an error may occur in an operation of the semiconductor device with a highest probability when the semiconductor device corresponds to an n-type transistor having a regular threshold voltage, all portions of a left active region of the semiconductor device are cut by a shallow trench, no portion of a right active region of the semiconductor device is cut by a shallow trench, and both the semiconductor device and the adjacent semiconductor device include three fins.

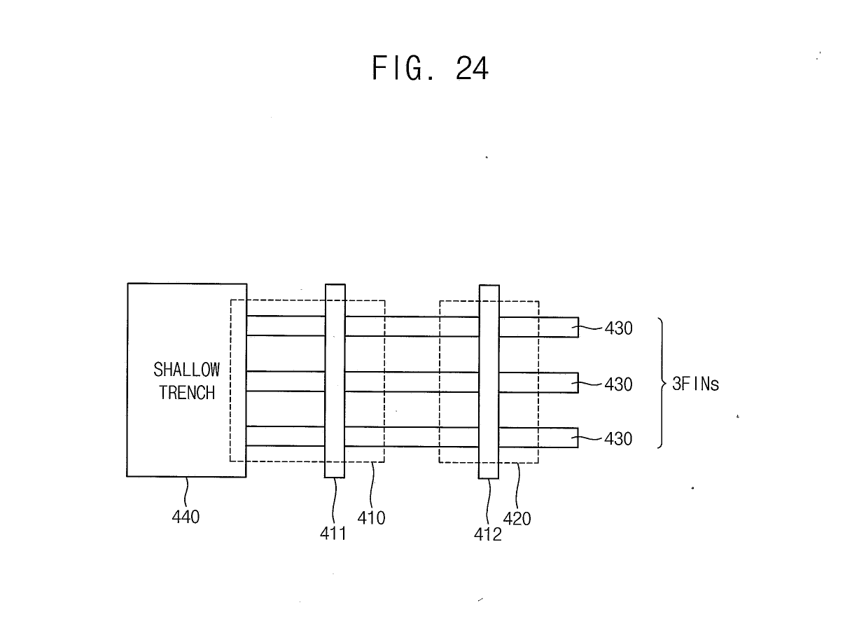

FIG. 24 illustrates a diagram of an example of a semiconductor device generated based on a combination of weak values of weak design attributes, which are determined by the processes of FIGS. 18 to 23.

Referring to FIG. 24, a first transistor 410 (which may correspond to at least one of the plurality of semiconductor devices 200-1, 200-2, . . . 200-n of FIG. 1) of an n-type may include a gate 411 such that the first transistor 410 may have a regular threshold voltage. All portions of a left active region of the first transistor 410 may be cut by a shallow trench 440, and no portion of a right active region of the first transistor 410 may be cut by a shallow trench. In addition, the first transistor 410 may include three fins 430. An adjacent transistor 420 having a gate 412 may also include three fins 430. In this case, the semiconductor device analysis apparatus 100 may determine that an error may occur in an operation of the first transistor 410 with a highest probability from among the plurality of semiconductor devices 200-1, 200-2, . . . , 200-n.

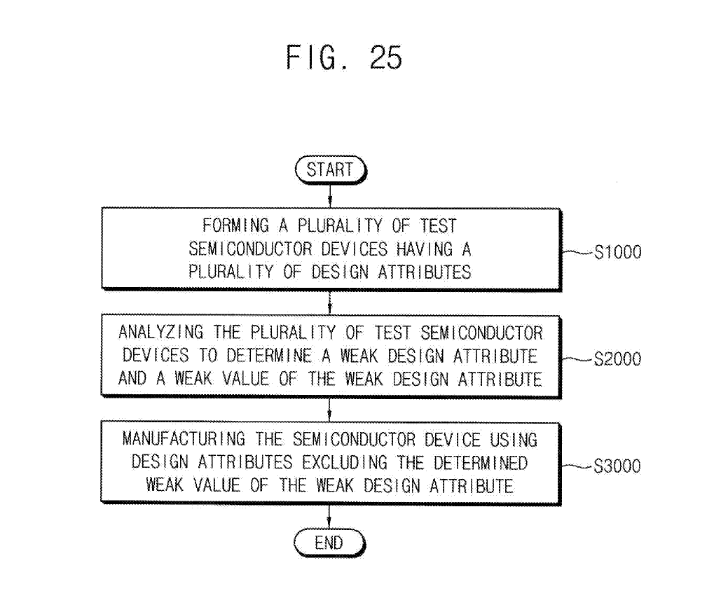

FIG. 25 illustrates a flow chart of a method of manufacturing a semiconductor device according to an embodiment of the inventive concept. Referring to FIG. 25, in step S1000 a plurality of test semiconductor devices having a plurality of design attributes may be formed. The plurality of test semiconductor devices may for example correspond to the plurality of test semiconductor devices DUT 200-1, 200-2, . . . 200-n as shown in FIG. 1. The plurality of test semiconductor devices may be formed on a plurality of semiconductor chips 310 on one or more wafers 300 as shown in FIG. 2 for example. The test semiconductor devices may for example be transistors formed using a plurality of design attributes such as described with respect to FIG. 4 for example. Various other design attributes such as shown in FIGS. 13 and 18-22 may also be used in forming the plurality of test semiconductor devices.

After forming the plurality of test semiconductor devices in step S1000, the plurality of test semiconductor devices in step S2000 may be analyzed using various embodiments of the method of analyzing as described with respect to FIGS. 1-13, to determine a weak design attribute among the plurality of design attributes and a weak value of the weak design attribute which causes the outlier values in the output values of the test semiconductor devices.

The semiconductor device may thereafter be manufactured in step S3000 using design attributes from among the plurality of design attributes excluding the determined weak value of the weak design attribute.

In other embodiments of the inventive concept, after forming the plurality of test semiconductor devices in step S1000, the plurality of test semiconductor devices may instead thereafter be analyzed in step S2000 using various embodiments of the method of analyzing a semiconductor device as described with respect to FIGS. 14-23.

Hereinabove, the method of analyzing a semiconductor device according to embodiments of the inventive concept are described with reference to FIGS. 1 to 24. However, the methods of determining the weak design attribute and the weak value of the weak design attribute, which has a high probability to cause an error, may be applied to any other fields or devices. For example, the methods of determining the weak design attribute and the weak value of the weak design attribute, which has a high probability to cause an error in the plurality of semiconductor devices 200-1, 200-2, . . . , 200-n, described above with reference to FIGS. 1 to 24 may be applied in determining a weak attribute among a plurality of attributes and a weak value of the weak attribute, which has a high probability to cause an error in a plurality of devices of any kind, based on a plurality of output values measured from the plurality of devices, which are manufactured based on various values of the plurality of attributes.

The foregoing is illustrative of the present inventive concept and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of analyzing a semiconductor device, comprising:
measuring a plurality of output values of a plurality of semiconductor devices;
determining population data including the plurality of output values corresponding with values of a plurality of design attributes of each of the plurality of semiconductor devices;
extracting a plurality of outlier output values from among the plurality of output values included in the population data to determine discriminated data; and
determining a weak design attribute from among the plurality of design attributes and a weak value of the weak design attribute which causes the outlier output values, based on a difference between a first ratio of a number of outlier output values, which are related with respective values of the plurality of design attributes, from among the plurality of outlier output values included in the discriminated data to a total number of the plurality of outlier output values included in the discriminated data, and a second ratio of a number of output values, which are related with respective values of the plurality of design attributes, from among the plurality of output values included in the population data to a total number of the plurality of output values included in the population data.

2. The method of claim 1, wherein said extracting the plurality of outlier output values from among the plurality of output values included in the population data to determine the discriminated data comprises:
extracting the plurality of outlier output values from among the plurality of output values included in the population data based on a difference between each of the plurality of output values included in the population data and an average value of the plurality of output values included in the population data to determine the discriminated data.

3. The method of claim 1, wherein said extracting the plurality of outlier output values from among the plurality of output values included in the population data to determine the discriminated data comprises:
listing the plurality of output values included in the population data in an order of a magnitude;
extracting a first number of output values from an end of the listed output values as the plurality of outlier output values, the first number being determined by multiplying the total number of the plurality of output values included in the population data and a reference ratio; and
determining the plurality of outlier output values as the discriminated data.

4. The method of claim 1, wherein each of the plurality of output values included in the population data includes a pair of a first output value and a second output value, and
wherein said extracting the plurality of outlier output values from among the plurality of output values included in the population data to determine the discriminated data comprises:
displaying the plurality of output values on a plane having an x-axis corresponding to a magnitude of the first output value and a y-axis corresponding to a magnitude of the second output value;
extracting output values included in an area on the plane, which is formed by an ellipse line on which a Mahalanobis distance of the first output value and the second output value corresponds to a reference value and at least one of a horizontal line tangent to the ellipse line and a vertical line tangent to the ellipse line, as the plurality of outlier output values; and
determining the plurality of outlier output values as the discriminated data.

5. The method of claim 1, wherein said determining the weak design attribute from among the plurality of design attributes and the weak value of the weak design attribute comprises:
selecting each of the plurality of design attributes consecutively as an observation design attribute;
selecting each of values of the observation design attribute consecutively as an observation value;
determining the first ratio as a ratio of a number of outlier output values, which are related with the observation value of the observation design attribute, from among the plurality of outlier output values included in the discriminated data to the total number of the plurality of outlier output values included in the discriminated data, as a first occurrence rate;
performing a sampling loop a plurality of times, the sampling loop comprising randomly extracting a same number of output values from among the plurality of output values included in the population data as a total number of the plurality of outlier output values included in the discriminated data to determine sample data, and determining the second ratio as a ratio of a number of output values, which are related with the observation value of the observation design attribute, from among the output values included in the sample data to the total number of the output values included in the sample data, as a second occurrence rate;
determining a third occurrence rate representing a distribution of the second occurrence rates generated by performing the sampling loop the plurality of times; and
determining a gap based on a difference between the first occurrence rate and the third occurrence rate.

6. The method of claim 5, wherein said determining the gap based on the difference between the first occurrence rate and the third occurrence rate comprises:
calculating a standard deviation of the distribution of the second occurrence rates; and
determining a value, calculated by subtracting the third occurrence rate from the first occurrence rate and then dividing a difference between the third occurrence rate and the first occurrence rate by the standard deviation, as the gap.

7. The method of claim 5, wherein said determining the weak design attribute from among the plurality of design attributes and the weak value of the weak design attribute further comprises:
determining the observation design attribute and the observation value of the observation design attribute, which correspond to a maximum gap among the gaps determined based on the values of the plurality of design attributes, as the weak design attribute and the weak value of the weak design attribute, respectively.

8. A method of analyzing a semiconductor device, comprising:
measuring a plurality of output values of a plurality of semiconductor devices;
determining population data including the plurality of output values corresponding with values of a plurality of design attributes of each of the plurality of semiconductor devices;
extracting a plurality of outlier output values from among the plurality of output values included in the population data to determine discriminated data;
determining a first weak design attribute from among the plurality of design attributes and a first weak value of the first weak design attribute, which causes the outlier output values, based on values of design attributes related with the plurality of outlier output values included in the discriminated data and values of design attributes related with the plurality of output values included in the population data;
extracting output values, which are related with the first weak value of the first weak design attribute, from among the plurality of output values included in the population data to determine first new population data; and
determining a second weak design attribute from among the plurality of design attributes and a second weak value of the second weak design attribute, which causes the outlier output values, based on the first new population data.

9. The method of claim 8, wherein said determining the second weak design attribute and the second weak value of the second weak design attribute based on the first new population data comprises:
extracting outlier output values, which are related with the first weak value of the first weak design attribute, from among the plurality of outlier output values included in the discriminated data to determine new discriminated data; and
determining the second weak design attribute and the second weak value of the second weak design attribute, which causes the outlier output values, based on values of design attributes related with the outlier output values included in the new discriminated data and values of design attributes related with the output values included in the first new population data.

10. The method of claim 8, wherein said determining the second weak design attribute and the second weak value of the second weak design attribute based on the first new population data comprises:
extracting outlier output values from among the output values included in the first new population data to determine new discriminated data; and
determining the second weak design attribute and the second weak value of the second weak design attribute, which causes the outlier output values, based on values of design attributes related with the outlier output values included in the new discriminated data and values of design attributes related with the output values included in the first new population data.

11. The method of claim 8, further comprising:
determining the first weak value of the first weak design attribute and the second weak value of the second weak design attribute as a combination of weak values of weak design attributes, which causes the outlier output values.

12. The method of claim 8, further comprising:
extracting output values, which are related with the second weak value of the second weak design attribute, from among the output values included in the first new population data to determine second new population data; and
determining a third weak design attribute from among the plurality of design attributes and a third weak value of the third weak design attribute, which causes the outlier output values, based on the second new population data.

13. The method of claim 8, wherein from determining the first weak design attribute among the plurality of design attributes and the first weak value of the first weak design attribute comprises:
determining the first weak design attribute from among the plurality of design attributes and the first weak value of the first weak design attribute, which causes the outlier output values, based on a difference between a ratio of a number of outlier output values, which are related with respective values of the plurality of design attributes, from among the plurality of outlier output values included in the discriminated data to a total number of the plurality of outlier output values included in the discriminated data, and a ratio of a number of output values, which are related with respective values of the plurality of design attributes, from among the plurality of output values included in the population data to a total number of the plurality of output values included in the population data.

14. The method of claim 8, wherein said determining the first weak design attribute among the plurality of design attributes and the first weak value of the first weak design attribute comprises:
selecting each of the plurality of design attributes consecutively as an observation design attribute;
selecting each of values of the observation design attribute consecutively as an observation value;
determining a ratio of a number of outlier output values, which are related with the observation value of the observation design attribute, from among the plurality of outlier output values included in the discriminated data to a total number of the plurality of outlier output values included in the discriminated data, as a first occurrence rate;
performing a sampling loop a plurality of times, the sampling loop comprising randomly extracting a same number of output values from among the plurality of output values included in the population data as the total number of the plurality of outlier output values included in the discriminated data to determine sample data, and determining a ratio of a number of output values, which are related with the observation value of the observation design attribute, from among the output values included in the sample data to a total number of the output values included in the sample data, as a second occurrence rate;
determining a third occurrence rate representing a distribution of the second occurrence rates generated by performing the sampling loop the plurality of times; and
determining the first weak design attribute and the first weak value of the first weak design attribute based on a difference between the first occurrence rate and the third occurrence rate.

15. The method of claim 14, wherein from determining the first weak design attribute and the first weak value of the first weak design attribute based on the difference between the first occurrence rate and the third occurrence rate comprises:
calculating a standard deviation of the distribution of the second occurrence rates;
determining a value, calculated by subtracting the third occurrence rate from the first occurrence rate and then dividing a difference between the third occurrence rate and the first occurrence rate by the standard deviation, as a gap; and
determining the observation design attribute and the observation value of the observation design attribute, which correspond to a maximum gap among the gaps determined based on the values of the plurality of design attributes, as the first weak design attribute and the first weak value of the first weak design attribute, respectively.

16. A method of manufacturing a semiconductor device, comprising:
forming a plurality of test semiconductor devices having a plurality of design attributes;
measuring a plurality of output values of the plurality of test semiconductor devices;
determining population data including the plurality of output values corresponding with values of the plurality of design attributes of each of the plurality of test semiconductor devices;
extracting a plurality of outlier output values from among the plurality of output values included in the population data to determine discriminated data;
determining a weak design attribute from among the plurality of design attributes and a weak value of the weak design attribute which causes the outlier output values, based on a difference between a first ratio of a number of outlier output values, which are related with respective values of the plurality of design attributes, from among the plurality of outlier output values included in the discriminated data to a total number of the plurality of outlier output values included in the discriminated data, and a second ratio of a number of output values, which are related with respective values of the plurality of design attributes, from among the plurality of output values included in the population data to a total number of the plurality of output values included in the population data; and
manufacturing the semiconductor device using design attributes from among the plurality of design attributes excluding the weak value of the weak design attribute.

17. The method of manufacturing a semiconductor device of claim 16, wherein the plurality of test semiconductor devices and the semiconductor device are transistors.

18. The method of manufacturing a semiconductor device of claim 17, wherein the plurality of output values of the plurality of test semiconductor values comprise drain currents of the transistors in at least one of a cut-off state and a saturation state.

19. The method of manufacturing a semiconductor device of claim 16, wherein said extracting the plurality of outlier output values from among the plurality of output values included in the population data to determine the discriminated data comprises:
listing the plurality of output values included in the population data in an order of a magnitude;
extracting a first number of output values from an end of the listed output values as the plurality of outlier output values, the first number being determined by multiplying the total number of the plurality of output values included in the population data and a reference ratio; and
determining the plurality of outlier output values as the discriminated data.

20. The method of manufacturing a semiconductor device of claim 16, wherein each of the plurality of output values included in the population data includes a pair of a first output value and a second output value, and
wherein said extracting the plurality of outlier output values from among the plurality of output values included in the population data to determine the discriminated data comprises:
displaying the plurality of output values on a plane having an x-axis corresponding to a magnitude of the first output value and a y-axis corresponding to a magnitude of the second output value;
extracting output values included in an area on the plane, which is formed by an ellipse line on which a Mahalanobis distance of the first output value and the second output value corresponds to a reference value and at least one of a horizontal line tangent to the ellipse line and a vertical line tangent to the ellipse line, as the plurality of outlier output values; and
determining the plurality of outlier output values as the discriminated data.
